(19) United States
(12) Patent Application Publication
(10) Pub. No.: US 2018/0082618 A1
(43) Pub. Date: Mar. 22, 2018

(54) DISPLAY CONTROL DEVICE, DISPLAY SYSTEM, AND DISPLAY CONTROL METHOD

(71) Applicants: Nobuyuki KISHI, Tokyo (JP); Mana AKAIKE, Tokyo (JP)

(72) Inventors: Nobuyuki KISHI, Tokyo (JP); Mana AKAIKE, Tokyo (JP)

(21) Appl. No.: 15/702,780

(22) Filed: Sep. 13, 2017

(30) Foreign Application Priority Data
Sep. 16, 2016 (JP) 2016-182389

(51) Int. Cl. G09G 3/00; G06T 7/543; H04N 9/31

(52) U.S. Cl. CPC G09G 3/003; G06T 7/543; H04N 9/3147; G06T 19/20; G06T 2219/2016; G06T 2219/2021; G06T 2207/10008

(57) ABSTRACT

An apparatus, system, and method, each of which acquires a user image having a first shape, the user image including a drawing image that has been manually drawn by a user, controls one or more displays to display a first image having the first shape, created based on the user image, in a display area of a display medium, and further display a second image having a second shape different from the first shape, created based on the user image, in the display area of the display medium.

### CROSS-REFERENCE TO RELATED APPLICATIONS

This patent application is based on and claims priority pursuant to 35 U.S.C. § 119(a) to Japanese Patent Application No. 2016-182389, filed on Sep. 16, 2016, in the Japan Patent Office, the entire disclosure of which is hereby incorporated by reference herein.

### BACKGROUND

### Technical Field

The present invention relates to a display control device, a display system, and a display control method.

### Description of the Related Art

Performance improvement of computer devices in recent years has permitted easier display of an image formed by computer graphics (hereinafter abbreviated as 3D CG) based on three-dimensional coordinates.

Moreover, 3D CG utilized in wide fields sets a regular or random movement for each of objects disposed in a three-dimensional coordinate space to display the objects as a moving image. The respective objects expressed in this moving image are allowed to move independently from each other in the three-dimensional coordinate space.

In addition, 3D CG arranges a user image created by a user in a three-dimensional coordinate space prepared beforehand, and moves the user image within the three-dimensional coordinate space. However, when the movement of the user image is only an unchanging and monotonous movement as viewed from the user, it may be difficult to attract the user.

### SUMMARY

Example embodiments of the present invention include an apparatus, system, and method, each of which acquires a user image having a first shape, the user image including a drawing image that has been manually drawn by a user, controls one or more displays to display a first image having the first shape, created based on the user image, in a display area of a display medium, and further display a second image having a second shape different from the first shape, created based on the user image, in the display area of the display medium.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram schematically illustrating a configuration of a display system according to a first embodiment;

FIG. 2 is a view illustrating an example of an image projected on a screen from the display system according to the first embodiment;

FIG. 3 is a block diagram illustrating a configuration example of a display control device applicable to the first embodiment;

FIG. 4 is a functional block diagram illustrating an example of functions of the display control device according to the first embodiment;

FIGS. 5A through 5C are diagrams illustrating an example of a display area according to the first embodiment;

FIG. 6 is a flowchart illustrating an example of a document image reading process according to the first embodiment;

FIG. 7 is a view illustrating an example of a document sheet on which a handwritten image is created, in a form applicable to the first embodiment;

FIGS. 8A and 8B are views illustrating a state that a drawing has been created in a drawing area along a contour according to the first embodiment;

FIGS. 9A through 9D are views each illustrating an example of a second shape applicable to the first embodiment;

FIG. 10 is a flowchart illustrating an example of a display control process performed for user objects according to the first embodiment;

FIGS. 11A through 11C are views each illustrating an example of generation of a first user object applicable to the first embodiment;

FIGS. 12A through 12C are views each illustrating an example of generation of a second user object applicable to the first embodiment;

FIGS. 13-1A through 13-1C are views each illustrating the display control process according to the first embodiment;

FIGS. 13-2A and 13-2B are views each illustrating the display control process according to the first embodiment;

FIGS. 13-3A and 13-3B are views each illustrating the display control process according to the first embodiment;

FIG. 14 is a flowchart illustrating an example of a display control process for the second user object present in the display area according to the first embodiment;

FIGS. 15A and 15B are views each schematically illustrating a state of shifts of a plurality of the second user objects present in the display area according to the first embodiment;

FIG. 16 is a flowchart illustrating an example of an event display process according to the first embodiment;

FIG. 17-1 is a view illustrating an example of an image for event display according to the first embodiment;

FIGS. 17-2A and 17-2B are views each illustrating an example of an image for event display according to the first embodiment;

FIG. 17-3 is a view illustrating an example of an image for event display according to the first embodiment;

FIG. 18 is a view illustrating an example of an area extended to a coordinate z₂ according to the first embodiment;

FIGS. 19-1A and 19-1B are views each illustrating an example of a setting for a corresponding item given to a dinosaur #1 according to the first embodiment;

FIG. 19-2 is a view illustrating an example of a setting for a corresponding item given to the dinosaur #1 according to the first embodiment;

FIGS. 20-1A and 20-1B are views each illustrating an example of a setting for a corresponding item given to a dinosaur #2 according to the first embodiment;

FIG. 20-2 is a view illustrating an example of a setting for a corresponding item given to the dinosaur #2 according to the first embodiment;

FIGS. 21-1A and 21-1B are views each illustrating an example of a setting for a corresponding item given to a dinosaur #3 according to the first embodiment;

FIG. 21-2 is a view illustrating an example of a setting for a corresponding item given to the dinosaur #3 according to the first embodiment;

FIGS. 22-1A and 22-1B are views each illustrating an example of a setting for a corresponding item given to a dinosaur #4 according to the first embodiment;

FIG. 22-2 is a view illustrating an example of a setting for a corresponding item given to the dinosaur #4 according to the first embodiment;

FIG. 23-1 is a view illustrating an example of a document sheet on which a user draws a second shape in a form applicable to a second embodiment;

FIG. 23-2 is a view illustrating an example of a document sheet on which a user draws a second shape in a form applicable to the second embodiment;

FIG. 24 is a flowchart illustrating an example of a document image reading process according to the second embodiment;

FIGS. 25A and 25B are views illustrating a state of a drawing created in a drawing area along a contour according to the second embodiment;

FIGS. 26A through 26C are views each illustrating mapping of user image data on the second shape according to the second embodiment;

FIG. 27 is a flowchart illustrating an example of a document image reading process according to a third embodiment; and

FIG. 28 is a flowchart illustrating an example of a display control process according to the third embodiment.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

A display control device, a display control program, a display system, and a display control method according to embodiments are hereinafter described in detail with reference to the accompanying drawings.

### First Embodiment

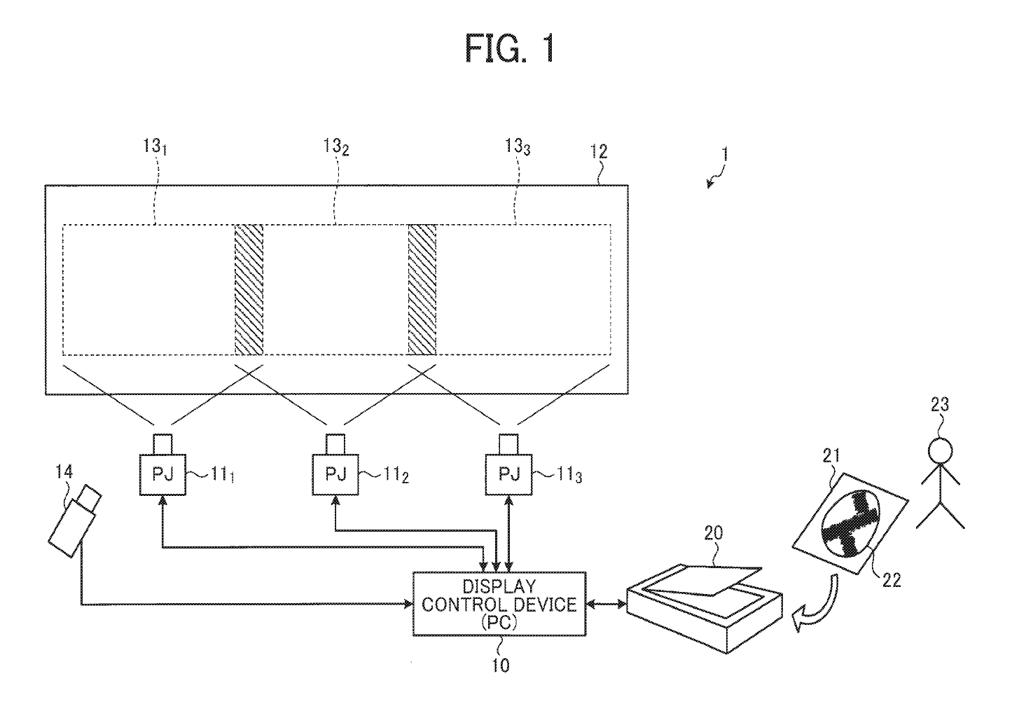

FIG. 1 schematically illustrates a configuration of a display system according to a first embodiment. A display system 1 illustrated in FIG. 1 includes a display control device 10, one or more projector devices (PJs) 11₁, 11₂, and 11₃, and a scanner device 20. The display control device 10 is implemented by a personal computer, for example. A sheet 21 is read by the scanner device 20 to acquire image data. Predetermined image processing is performed on the image data to acquire display image data. The display image data is sent to the PJs 11₁, 11₂, and 11₃. The PJs 11₁, 11₂, and 11₃ project images 13₁, 13₂, and 13₃ to a display medium such as a screen 12 based on the display image data sent from the display control device 10.

When the images 13₁, 13₂, and 13₃ are projected to the single screen 12 from the plurality of PJs 11₁, 11₂, and 11₃ as illustrated in FIG. 1, it is preferable that overlapping portions are produced between adjoining areas of the images 13₁, 13₂, and 13₃. According to the example illustrated in FIG. 1, a camera 14 captures an image of the respective images 13₁, 13₂, and 13₃ projected on the screen 12 to acquire image data from the captured image as data based on which the display control device 10 controls the respective images 13₁, 13₂, and 13₃, or the respective PJs 11₁, 11₂, and 11₃, and adjusts the overlapping portions.

According to this configuration, a user 23 draws, on a document sheet (“sheet”) 21, a handwritten drawing 22, for example. An image of the sheet 21 is read by the scanner device 20. According to the first embodiment, the drawing 22 is a colored drawing produced by coloring along a contour line provided beforehand. In other words, the user 23 performs a process for coloring the sheet 21 containing only a not-colored design. The scanner device 20 provides document image data read and acquired from the image of the sheet 21 to the display control device 10. The display control device 10 extracts image data indicating a design part, i.e., image data indicating a part corresponding to the drawing 22, from the document image data sent from the scanner device 20, and retains the extracted image data as user image data corresponding to a display processing target.

On the other hand, the display control device 10 generates an image data space based on a three-dimensional coordinate system expressed by coordinates (x, y, z), for example. According to the first embodiment, a user object having a three-dimensional shape and reflecting the drawing of the user is generated based on the user image data extracted from the two-dimensionally designed colored drawing. In other words, the two-dimensional user image data is mapped on a three-dimensionally designed object to generate the user object. The display control device 10 determines coordinates of the user object in the image data space to arrange the user object within the image data space.

The user may produce a three-dimensionally designed coloring drawing. When a paper medium such as the sheet 21 is used, a plurality of coloring drawings may be created and combined to generate a three-dimensional user object, for example.

Alternatively, instead of using paper, an information processing terminal including a display device and an input device integrated with each other, such as a tablet-type terminal, may be used to input coordinate information in accordance with a position designated by the user and input from the user to the input device, for example. In this case, the information processing terminal may display a three-dimensionally designed object in a screen displayed on the display device. The user may color the three-dimensionally designed object displayed in the screen of the information processing terminal while rotating the object by an operation input from the user to the input device to directly color the three-dimensional object.

Respective embodiments are described herein, based on the assumption that the user uses a paper medium such as the sheet 21 to create a drawing. However, technologies disclosed according to the present invention includes a technology applicable not only to an application mode using a paper medium, but also to an application mode using a screen displayed on an information processing terminal for creating a drawing. Accordingly, an application range of the technologies disclosed according to the present invention is not necessarily limited to an application mode using a paper medium.

The display control device 10 projects a three-dimensional data space including this user object to a two-dimensional image data plane, divides image data generated by this projection into the same number of divisions as the number of the PJs 11₁, 11₂, and 11₃, and provides the respective divisions of the image data to the corresponding PJs 11₁, 11₂, and 11₃.

The display control device 10 in this embodiment is capable of moving the user object within the image data space. For example, the display control device 10 calculates a feature value of user image data corresponding to the origin of the user object, and generates respective parameters indicating a movement of the user object based on the calculated feature value. The display control device 10 applies the generated parameters to the user object to move the user object within the image data space.

As a result, the user 23 is allowed to observe the user object corresponding to the handwritten drawing 22 created by the user 23 as an image moving in accordance with characteristics of the drawing 22 within the three-dimensional image data space. In addition, the display control device 10 is capable of arranging a plurality of user objects in an identical image data space. Accordingly, when a plurality of the users 23 performs the foregoing operation, the drawings 22 produced by the respective users 23 on the sheet 21 start shifting within the single image data space. Alternatively, the single user 23 may repeat the foregoing operation several times. In this case, the display control device 10 displays each of user objects corresponding a plurality of the different drawings 22 as an image moving in the three-dimensional image data space, while the user 23 observes the display of the images.

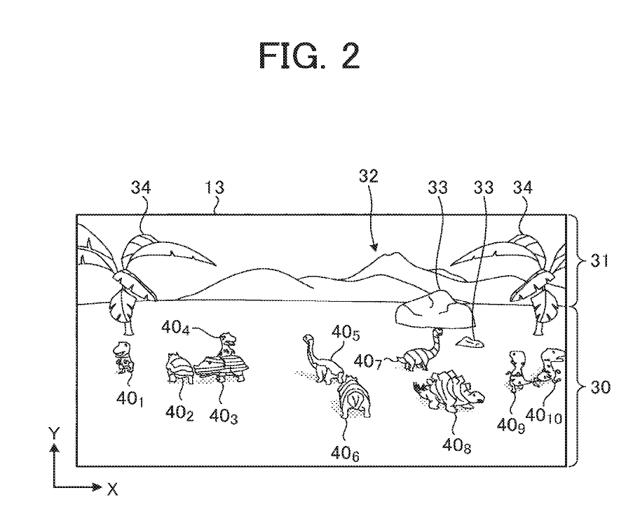

FIG. 2 illustrates an example of an image 13 projected to the screen 12 by the display system 1 according to the first embodiment. According to the example illustrated in FIG. 2, the image 13 is a merged image of the images 13₁, 13₂, and 13₃ formed adjacently to each other with overlapping portions produced between adjoining areas as illustrated in FIG. 1.

The display system 1 according to the first embodiment maps image data indicating the handwritten drawing 22 created by the user 23 (user image data) to produce a three-dimensional first user object based on a first shape, projects the first user object to a two-dimensional image data plane, and displays an image of the projected first user object in the image 13. This configuration will be detailed below. In addition, the display system 1 maps the image data indicating the drawing 22 to produce a three-dimensional second user object based on a second shape different from the first shape, arranges the second user object in the three-dimensional image data space, projects the arranged second user object to the two-dimensional image data plane, and displays an image of the projected second user object in the image 13 after display of the first user object. In this case, the display system 1 switches the image of the first user object currently displayed to the image of the second user object to display the image of the second user object in the image 13.

In the following description, an “image of a user object having a three-dimensional shape and projected to a two-dimensional image data plane” is simply referred to as a “user object” unless specified otherwise.

According to a more specific example, it is assumed that the first shape represents a shape of an egg, and that the second shape represents a shape of a dinosaur having a shape different from the first shape. Display of the first user object having the first shape is switched to display of the second user object having the second shape in the image 13 to express hatching of a dinosaur from an egg. The user 23 colors the sheet 21 which contains a design of an egg for coloring. The handwritten drawing 22 created by the user 23 with free patterns in various random colors is reflected in the display of the first user object as a pattern of an egg shell represented by the first shape, and is also reflected in the display of the second user object as a pattern of the dinosaur represented by the second shape. In this case, the user 23 views an animation expressing hatching of the dinosaur reflecting the pattern created by the user 23 from the egg having the same pattern. This animation attracts interest and concern, or curiosity from the user 23.

It is assumed that the horizontal direction and the vertical direction of the image 13 are an X direction and a Y direction, respectively, in FIG. 2. The image 13 is vertically divided into two divisions of upper and lower parts. The lower one of the two divisions is a land area 30 expressing the ground, while the upper one of the two divisions is a sky area 31 expressing the sky. A boundary between the land area 30 and the sky area 31 expresses the horizon. The land area 30 is a horizontal plane having a depth extending from the lower end of the image 13 toward the horizon. This configuration will be detailed below.

The image 13 in FIG. 2 includes a plurality of second user objects 40₁ through 40₁₀ in the land area 30. Each different image data indicating the corresponding different drawing 22 is mapped on corresponding one of the second user objects 40₁ through 40₁₀. Each of the second user objects 40₁ through 40₁₀ is capable of walking (shifting) in a random direction on the horizontal plane such as the land area 30, for example. This configuration will be detailed below. The image 13 may include a user object flying (shifting) in the sky area 31.

The image 13 includes fixed objects 33 representing rocks, and fixed objects 34 representing trees. The fixed objects 33 and 34 are arranged at fixed positions with respect to the horizontal plane such as the land area 30. The fixed objects 33 and 34 are expected to produce visual effects in the image 13, and function as obstacles for the shifts of the respective second user objects 40₁ through 40₁₀. In addition, a background object 32 of the image 13 is arranged at a fixed position in the deepest portion of the land area 30 (e.g., position on horizon). The background object 32 is provided chiefly for producing a visual effect in the image 13.

As described above, the display system 1 according to the first embodiment maps image data indicating the handwritten drawing 22 created by the user 23 to generate the first user object, and displays the generated first user object in the image 13. In addition, the display system 1 maps image data indicating the drawing 22 to generate the second user object having a shape different from the shape of the first user object, and switches the first user object to the second user object to display the second user object in the image 13. Accordingly, the user 23 has a feeling of expectation about the manner of reflection of the drawing 22 created by the user 23 in the first user object, and in the second user object having a shape different from the shape of the first object.

When the shape of the drawing 22 changes from the original shape created by the user 23, the user 23 has such an impression that the object having the second shape has been generated based on the drawing 22 created by the user 23. Accordingly, consciousness of participation felt by the user 23 may effectively increase when the first shape expresses a shape identical to the shape of the handwritten drawing 22 created by the user 23. One of possible methods for this purpose is to initially display, on the display screen, the first user object which indicates contents of the coloring drawing created by the user 23 and reflects these contents in the three-dimensional first shape based on the drawing 22 colored by the user 23 in accordance with the two-dimensional first shape designed on the sheet 21, and subsequently to display the second user object which indicates contents of the coloring drawing created by the user 23 and reflects these contents in the three-dimensional second shape.

### Configuration Example Applicable to First Embodiment

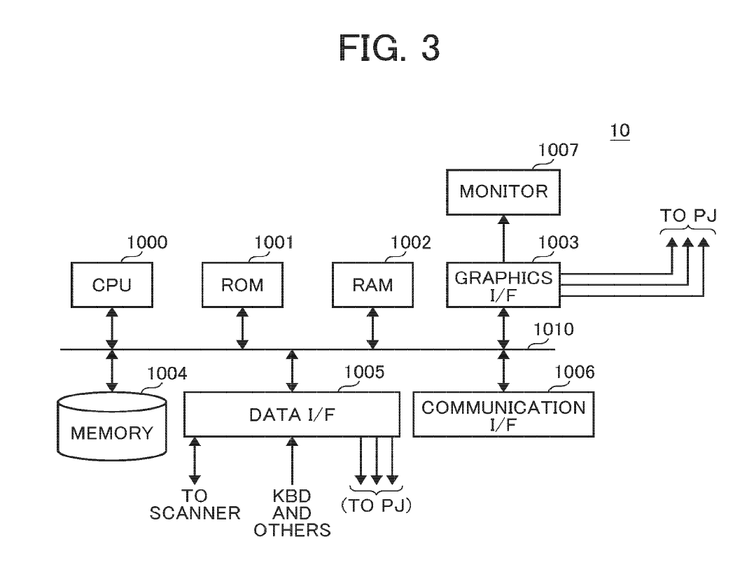

FIG. 3 is a configuration example of the display control device 10 applicable to the first embodiment. According to the display control device 10 illustrated in FIG. 3, a central processing unit (CPU) 1000, a read only memory (ROM) 1001, a random access memory (RAM) 1002, and a graphics interface (I/F) 1003 are connected to a bus 1010. According to the display control device 10, a memory 1004, a data I/F 1005, and a communication I/F 1006 are further connected to the bus 1010. Accordingly, the display control device 10 may have a configuration equivalent to a configuration of a general-purpose personal computer.

The CPU 1000 controls the entire operation of the display control device 10 according to programs, which are previously stored in the ROM 1001 and the memory 1004, and read into the RAM 1002 as a work memory for execution. The graphics I/F 1003 connected to a monitor 1007 converts display control signals generated by the CPU 1000 into signals for display by the monitor 1007, and outputs the converted signals. The graphics I/F 1003 may also convert display control signals into signals for display by the PJs 11₁, 11₂, and 11₃, and outputs the converted signals.

The memory 1004 is a storage medium capable of storing data in a non-volatile manner, such as a hard disk drive, for example. Alternatively, the memory 1004 may be a non-volatile semiconductor memory, such as a flash memory. The memory 1004 stores programs executed by the CPU 1000 described above, and various types of data.

The data I/F 1005 controls input and output of data to and from an external device. For example, the data I/F 1005 functions as an interface for the scanner device 20. Signals from a pointing device such as a mouse, or a keyboard (KBD) are input to the data IN 1005. Display control signals generated from the CPU 1000 may be further output from the data I/F 1005, and sent to the respective PJs 11₁, 11₂, and 11₃, for example. The data I/F 1005 may be a universal serial bus (USB), Bluetooth (registered trademark), or an interface of other types.

The communication I/F 1006 controls communication performed via a network such as the Internet and a local area network (LAN).

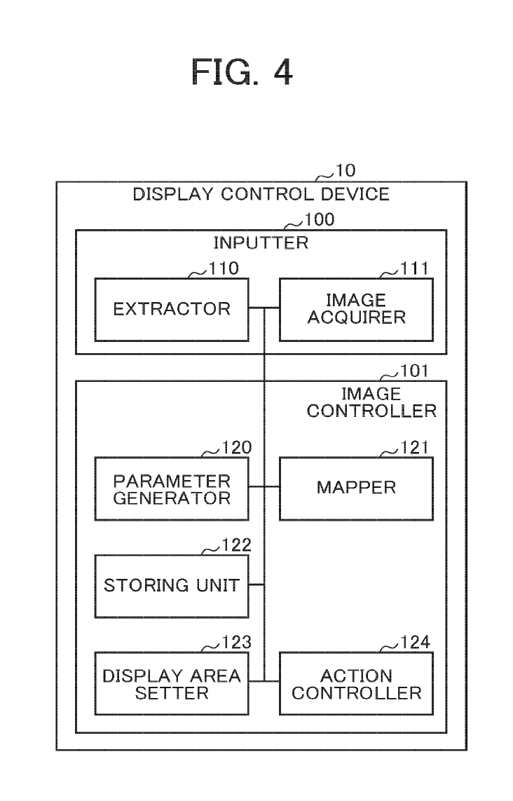

FIG. 4 is a functional block diagram illustrating an example of functions of the display control device 10 according to the first embodiment. The display control device 10 illustrated in FIG. 4 includes an inputter 100 and an image controller 101. The inputter 100 includes an extractor 110 and an image acquirer 111. The image controller 101 includes a parameter generator 120, a mapper 121, a storing unit 122, a display area setter 123, and an action controller 124.

The extractor 110 and the image acquirer 111 included in the inputter 100, and the parameter generator 120, the mapper 121, the storing unit 122, the display area setter 123, and the action controller 124 included in the image controller 101 are implemented as a display control program operated by the CPU 1000. Alternatively, the extractor 110, the image acquirer 111, the parameter generator 120, the mapper 121, the storing unit 122, the display area setter 123, and the action controller 124 may be implemented as hardware circuits operating in cooperation with each other.

The inputter 100 inputs a user image including the drawing 22 created by handwriting. More specifically, the extractor 110 of the inputter 100 extracts an area including a handwritten drawing, and predetermined information based on a pre-printed image (e.g., marker) on the sheet 21 from image data sent from the scanner device 20. The image data is data read and acquired from the sheet 21. The image acquirer 111 acquires an image of the handwritten drawing 22 corresponding to a user image from the area extracted by the extractor 110 from the image data sent from the scanner device 20.

The image controller 101 displays a user object in the image 13 based on the user image input to the inputter 100. More specifically, the parameter generator 120 of the image controller 101 analyzes the user image input from the inputter 100. The parameter generator 120 further generates parameters for the user object corresponding to the user image based on an analysis result of the user image. These parameters are used for control of movement of the user object in an image data space. The mapper 121 maps user image data on a three-dimensional model having three-dimensional coordinate information prepared beforehand. The storing unit 122 controls data storage and reading in and from the memory 1004, for example.

The display area setter 123 sets a display area displayed in the image 13 based on the image data space having a three-dimensional coordinate system and represented by coordinates (x, y, z). More specifically, the display area setter 123 sets the land area 30 and the sky area 31 described above in the image data space. The display area setter 123 further arranges the background object 32, and the fixed objects 33 and 34 in the image data space. The action controller 124 causes a predetermined action of the user object displayed in the display area set by the display area setter 123.

The display control program for implementing respective functions of the display control device 10 according to the first embodiment is stored on a computer-readable recording medium, such as a compact disk (CD), a flexible disk (FD), a digital versatile disk (DVD), etc., in a file of an installable or executable format. Alternatively, the display control program may be stored in a computer connected to a network such as the Internet, and downloaded via the network to be provided. Alternatively, the display control program may be provided or distributed via a network such as the Internet.

The display control program has a module configuration including the foregoing respective units (extractor 110, image acquirer 111, parameter generator 120, mapper 121, storing unit 122, display area setter 123, and action controller 124). According to the practical hardware, the CPU 1000 reads the display control program from the storage medium such as the memory 1004, and executes the display control program to load the respective foregoing units into the RAM 1002 or other types of main storage device, to implement as the extractor 110, the image acquirer 111, the parameter generator 120, the mapper 121, the storing unit 122, the display area setter 123, and the action controller 124 in the main storage device.

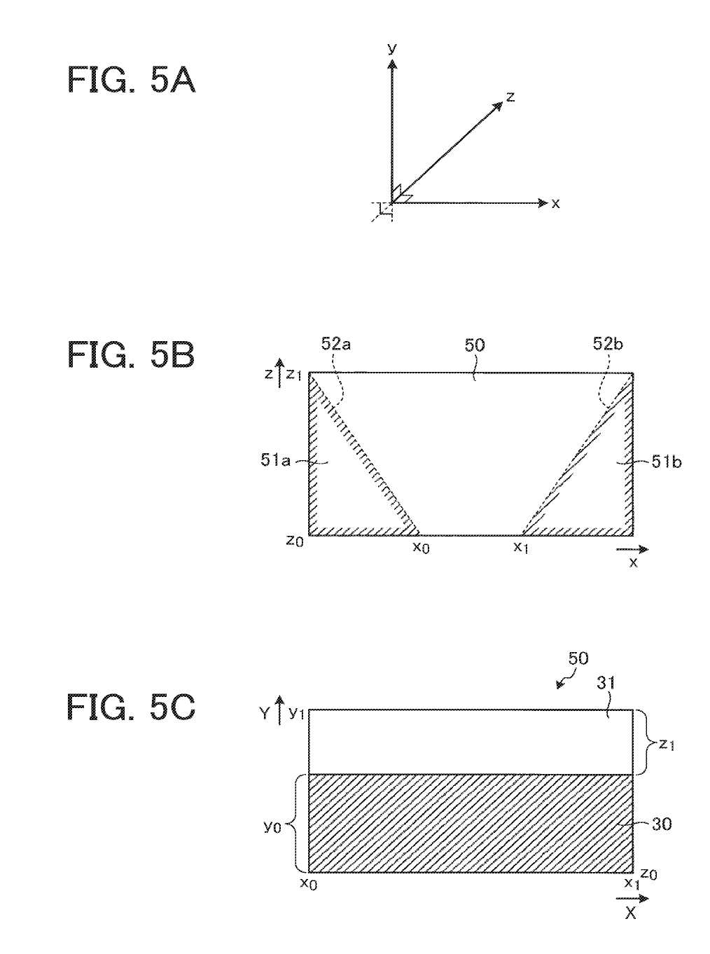

FIGS. 5A through 5C each illustrate an example of the display area set by the display area setter 123 according to the first embodiment. As illustrated in FIG. 5A, the image data space is defined by coordinates (x, y, z) defined by an x axis, a y axis, and a z axis crossing each other at right angles. The x axis represents the horizontal direction, the y axis represents the vertical direction, and the z axis represents the depth direction.

FIG. 5B illustrates the horizontal plane, i.e., the x-z plane in the image data space. According to the example illustrated in FIG. 5B, a range displayed as the image 13 lies in a range from a coordinate x=x₀ to a coordinate x=x₁ in the x axis direction at the frontmost position in the z axis, i.e., at a coordinate z=z₀. The depth direction of the image 13 is expressed by emphasized perspective. In this case, the display range in the x axis direction increases with nearness to a deeper coordinate z=z₁ from the coordinate z=z₀. A display area 50 displayed as the image 13 in the image data space is an area sandwiched between extension lines 52a and 52b extending in the z axis direction toward the coordinate x=x₀ and the coordinate x=x₁, respectively, in FIG. 5B. Areas 51a and 51b located outside the extension lines 52a and 52b are defined by coordinates, but are not displayed in the image 13. The areas 51a and 51b are hereinafter referred to as non-display areas 51a and 51b, respectively.

FIG. 5C illustrates the image 13 in an X direction (horizontal direction) and a Y direction (vertical direction) of the image 13. The image 13 displays the whole of the display area 50, for example. According to the example illustrated in FIG. 5C, one and the other ends of the image 13 in the X direction at the lower end of the image 13 in the Y direction correspond to the coordinate x₀ and the coordinate x₁ in the x direction in the image data space. Lines extending in the Y direction from the coordinates x₀ and x₁ correspond to the extension lines 52a and 52b, respectively, illustrated in FIG. 5B. The land area 30 includes a plane (horizontal plane) represented by a coordinate y₀ and the coordinates z₀ through z₁ in the image 13. The sky area 31 includes a plane represented by the coordinate z₁ and the coordinates y₀ through y₁ in the image 13, for example.

The display area setter 123 is capable of varying a ratio of the land area 30 to the sky area 31 in the image 13. A viewpoint of a user for the display area 50 is changeable in accordance with the ratio of the land area 30 to the sky area 31 in the image 13.

### Document Reading Process in First Embodiment

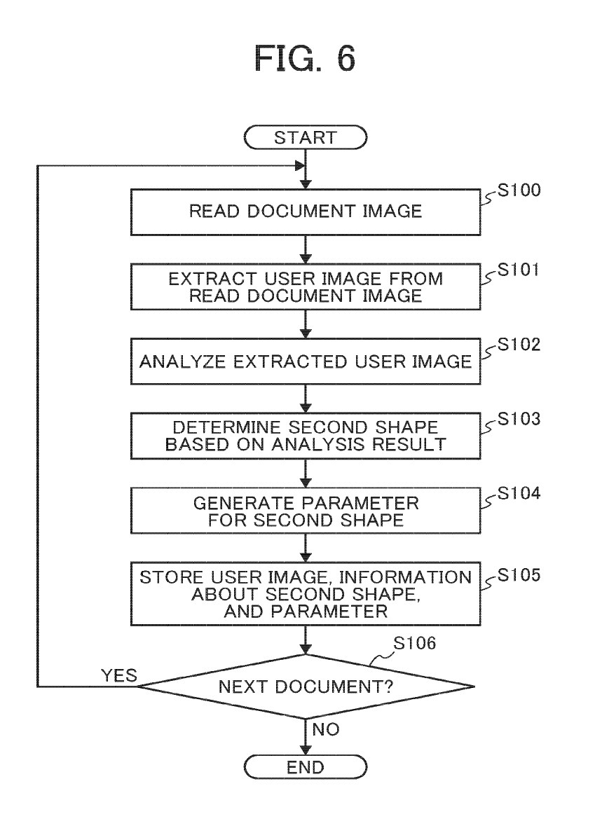

FIG. 6 is a flowchart illustrating an example of a document image reading process according to the first embodiment. A handwritten drawing is initially created by the user prior to execution of the process illustrated in this flowchart. It is assumed that the user creates a handwritten drawing on a sheet in a format determined beforehand. The dedicated sheet used by the user is sent from a service provider that provides a service with the display system 1 according to this embodiment.

It is further assumed that the image controller 101 expresses, in the image 13, hatching of a dinosaur from an egg by switching display of the first user object based on the first shape representing an egg shape to display of the second user object based on the second shape representing a dinosaur shape as described above. The user creates a handwritten drawing on the sheet to display the drawing on the first user object based on the first shape. According to the first shape representing the shape of the egg in this example, the handwritten drawing is a pattern of an egg shell displayed on the first user object.

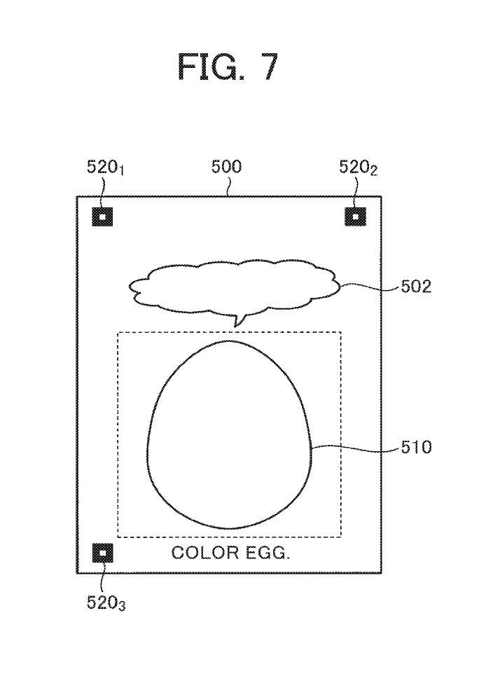

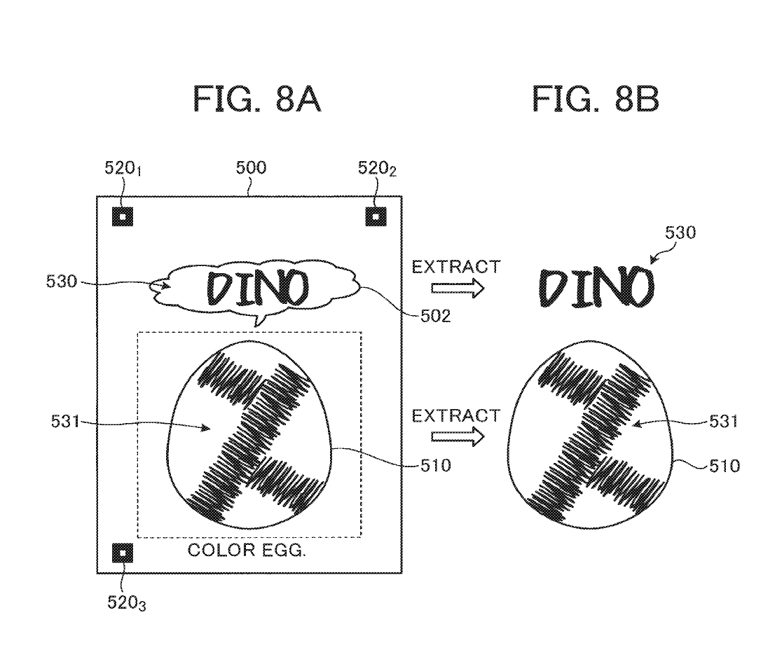

FIG. 7 illustrates an example of the sheet used for a handwritten drawing applicable to the first embodiment. A sheet 500 illustrated in FIG. 7 includes a title entry area 502 for entry of a title, and a drawing area 510 for a drawing by the user. According to this example, a design representing a contour of an egg shape is given as the drawing area 510. Illustrated in FIG. 8A is a state that a drawing 531 has been created in the drawing area 510, and that a title image 530 indicating a title has been created in the title entry area 502.

The sheet 500 further includes markers 520₁, 520₂, and 520₃ at three of four corners of the sheet 500. The markers 520₁, 520₂, and 520₃ are markers used for detecting the orientation and size of the sheet 500.

In the flowchart illustrated in FIG. 6, an image of the sheet 500 including the handwritten drawing 531 created by the user is read by the scanner device 20. Document image data indicating the read image is sent to the display control device 10, and input to the inputter 100 in step S100.

In subsequent step S101, the extractor 110 included in the inputter 100 of the display control device 10 extracts user image data from the input document image data.

Initially, the extractor 110 of the inputter 100 detects the respective markers 520₁, 520₂, and 520₃ from the document image data by utilizing pattern matching, for example. The extractor 110 determines the orientation and size of the document image data based on the positions of the respective detected markers 520₁, 520₂, and 520₃ in the document image data. The position of the drawing area 510 in the sheet 500 is determined. Accordingly, the drawing area 510 included in the document image data is extractable based on a relative position corresponding to a ratio of the document sheet size to the image size when this ratio is recognizable from information indicating the position of the drawing area 510 in the sheet 500 and stored in the memory 1004 beforehand in a state of the adjusted orientation of the document image data based on the markers 520. The extractor 110 therefore extracts the drawing area 510 from the document image data based on the orientation and size of the document image data acquired by the foregoing method.

The image in the area surrounded by the drawing area 510 is handled as user image data. The user image data may include a drawing part including a drawing drawn by the user, and a blank part remaining as a blank as no drawing is received. Drawing in the drawing area 510 is determined by the user.

The image acquirer 111 acquires the image 530 in the title entry area 502 as title image data based on information indicating the position of the title entry area 502 in the sheet 500 and stored in the memory 1004 beforehand. Illustrated in FIG. 8B is an example of the image indicated by the image data in the drawing area 510 and the title entry area 502 extracted from the document image data.

The inputter 100 transfers the user image data and the title image data acquired by the image acquirer 111 to the image controller 101.

In subsequent step S102, the parameter generator 120 of the image controller 101 analyzes the user image data extracted in step S101. In subsequent step S103, the parameter generator 120 of the image controller 101 selects the second shape corresponding to the user image data from a plurality of the second shapes based on the analysis result of a user image data.

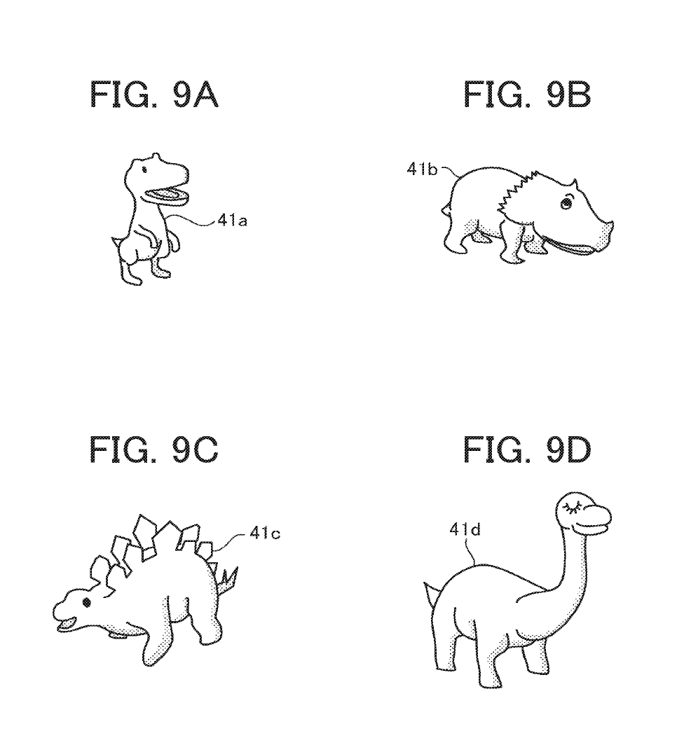

FIGS. 9A through 9D illustrate examples of the second shape applicable to the first embodiment. As illustrated in FIGS. 9A through 9D by way of example, the display system 1 according to the first embodiment prepares different four shapes 41a, 41b, 41c, and 41d beforehand as a plurality of the second shapes, for example. According to the examples in FIGS. 9A through 9D, the shape 41a represents a dinosaur “Tyrannosaurus”, the shape 41b represents a dinosaur “Triceratops”, the shape 41c represents a dinosaur “Stegosaurus”, and the shape 41d represents a dinosaur “Brachiosaurus”. While the plurality of types of second shapes are unified into types belonging to the same category of dinosaurs, the types of second shapes are not necessarily required to be unified into the same category.

Each of the four shapes 41a through 41d is prepared beforehand as three-dimensional shape data having three-dimensional coordinate information. Features (action features) including a shift speed range, an action during shift, and an action during stop of each of the four shapes 41a through 41d are set beforehand for each type. The three-dimensional shape data indicating each of the shapes 41a through 41d defines a direction. The shift direction of a shift within the display area 50 is controlled in accordance with the direction defined by the corresponding three-dimensional shape data. The three-dimensional shape data indicating each of the shapes 41a through 41d is stored in the memory 1004, for example.

The parameter generator 120 analyzes the user image data to calculate respective feature values of the user image data, such as color distribution, edge distribution, and area and center of gravity of the drawing part of the user image data. The parameter generator 120 selects the second shape corresponding to the user image data from a plurality of the second shapes based on one or more feature values included in the respective feature values calculated from an analysis result of the user image data.

Alternatively, the parameter generator 120 may use other information acquirable from the analysis result of the user image data as feature values for determining the second shape. The parameter generator 120 may further analyze the title image data to use an analysis result of the title image data as feature values for determining the second shape. Furthermore, the parameter generator 120 may determine the second shape based on the feature values of the entire document image data, or may randomly determine the second shape to be used without utilizing the feature values of the image data.

In this case, the user does not know which type of shape (dinosaur) appears until actual display of the shape in the display screen. This situation is expected to produce an effect of entertaining the user. When the second shape to be used is simply determined at random, whether or not a shape desired by the user appears is left to chance. On the other hand, when determination of the second shape to be used is affected by information acquired from the document image data, there may exist a rule controllable by the user creating a drawing on the sheet. The user finds the rule more easily as the information acquired from the document image data becomes simpler. In this case, the user is allowed to intentionally obtain the desired type of shape (dinosaur). The parameters to be used for determination may be selected based on the desired level of randomness for determining the second shape to be used.

Accordingly, information (e.g., markers) for identifying the second shape from a plurality of types of the second shapes may be printed on the sheet 500 beforehand, for example. In this case, for example, the extractor 110 of the inputter 100 extracts the information from the document image data read from the image of the sheet 500, and determines the second shape based on the extracted information.

In subsequent step S104, the parameter generator 120 generates respective parameters for the user object indicated by the user image data based on the one or more feature values of the respective feature values acquired by analysis of the user image data in step S102.

In subsequent step S105, the storing unit 122 of the image controller 101 stores, in the memory 1004, the user image data, and the information and parameters indicating the second shape determined and generated by the parameter generator 120. The storing unit 122 of the image controller 101 further stores the title image in the memory 1004.

In subsequent step S106, the inputter 100 determines whether a next document image to be read is present. When the inputter 100 determines that a next document image to be read is present (“Yes” in step S106), the processing returns to step S100. On the other hand, when the inputter 100 determines that a next document image to be read is absent (“No” in step S106), a series of the processes illustrated in the flowchart of FIG. 6 ends. The inputter 100 may determine whether to read a next document image based on a user operation input to the display control device 10, for example.

### Display Control Process in First Embodiment

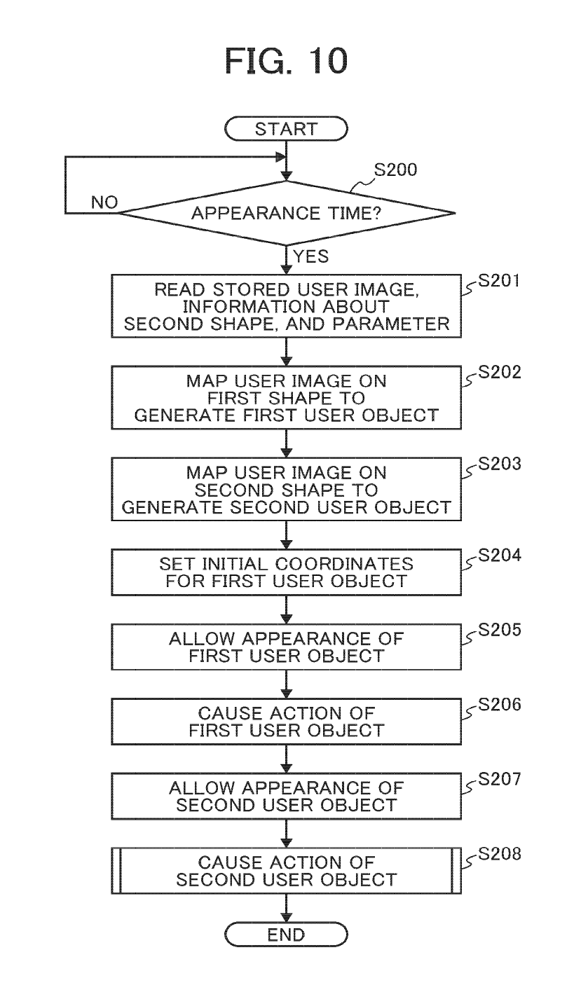

FIG. 10 is a flowchart showing an example of a display control process performed on a user object according to the first embodiment. In step S200, the image controller 101 determines whether or not the current time is a time for appearance of a user object corresponding to user image data in the display area 50. When the image controller 101 determines that the current time is not the time for appearance of the user object (“No” in step S200), the processing returns to step S200 to wait for the appearance time. On the other hand, when the image controller 101 determines that the current time is the appearance time of the user object (“Yes” in step S200), the processing proceeds to step S201.

For example, the appearance time of the user object may be the time when the display control device 10 receives the document image data, which is read from the sheet 500 containing the drawing of the user by the scanner device 20. In other words, the display control device 10 may allow appearance of a new user object in the display area 50 in response to an event that the sheet 500 including the drawing 22 of the user has been acquired by the scanner device 20.

In step S201, the storing unit 122 of the image controller 101 reads, from the memory 1004, the user image data stored in step S105 in the flowchart of FIG. 6 described above, and the information and parameters indicating the second shape. The user image data and the information indicating the second shape read from the memory 1004 are transferred to the mapper 121. On the other hand, the parameters read from the memory 1004 are transferred to the action controller 124.

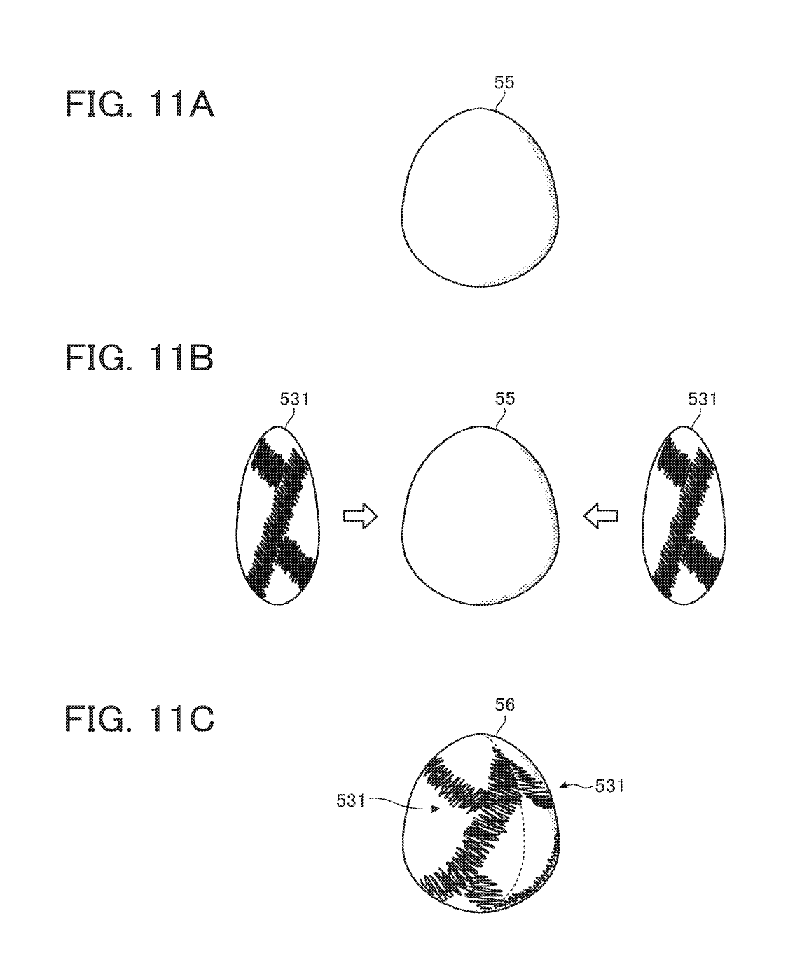

In subsequent step S202, the mapper 121 of the image controller 101 maps the user image data on the first shape prepared beforehand to generate the first user object. FIGS. 11A through 11C each illustrate an example of generation of the first user object applicable to the first embodiment. FIG. 11A illustrates an example of a shape 55 representing an egg shape as the first shape. The shape 55 is prepared beforehand as three-dimensional shape data having three-dimensional coordinate information, and stored in the memory 1004, for example.

FIG. 11B illustrates an example of mapping of the user image data on the shape 55. According to the first embodiment, the user image data indicating the drawing 531 created in accordance with the drawing area 510 of the sheet 500 is mapped on each of one half surface of the shape 55, and on the other half surface of the shape 55 as indicated by arrows in FIG. 11B. In other words, according to this example, two sets of user image data produced by copying the user image data indicating the drawing 531 are used for mapping. FIG. 11C illustrates an example of a first user object 56 generated in this manner. The mapper 121 stores the first user object 56 thus generated in the memory 1004, for example.

The method for mapping the user image data on the shape 55 is not limited to the foregoing method. For example, the user image data indicating the one drawing 531 may be mapped on the entire circumference of the shape 55. In this example, the sheet 500 and the first object represent the same first shape. It is therefore preferable that the user recognizes the pattern reflected in the first user object as a pattern identical to the pattern created by the user in the drawing area 510 of the sheet 500.

In subsequent step S203, the mapper 121 of the image controller 101 maps the user image data on the second shape based on the information received from the storing unit 122 in step S201 and indicating the corresponding second shape to generate the second user object.

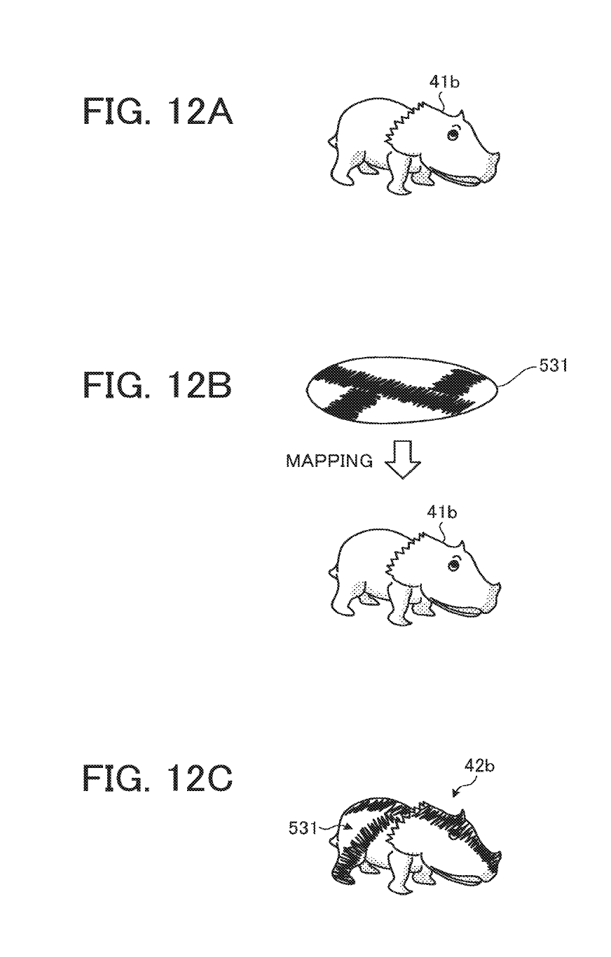

FIGS. 12A through 12C each illustrate an example of generation of the second user object applicable to the first embodiment. FIG. 12A illustrates the shape 41b representing a shape of a dinosaur as the second shape. The shape 41b is prepared beforehand as three-dimensional shape data having three-dimensional coordinate information, and stored in the memory 1004, for example.

FIG. 12B illustrates an example of mapping of the user image data on the shape 41b. According to the first embodiment, the user image data indicating the drawing 531 created in accordance with the drawing area 510 of the sheet 500 is mapped on the upper surface of the shape 41b as indicated by an arrow in FIG. 12B. In other words, in this example, only the one user image data indicating the drawing 531 is used for mapping. According to the example illustrated in FIG. 12B, the user image data indicating the drawing 531 is mapped on the shape 41b in a state that the center line of the egg shape including the drawing 531, i.e., the line connecting the top and the bottom side of the egg shape is aligned with the center line of the shape 41b representing the dinosaur, i.e., the line connecting the head and the tail of the dinosaur.

The mapper 121 also extends the user image data indicating the drawing 531 to map the data on a surface of the shape 41b invisible in the mapping direction. For example, in case of the shape 41b representing a dinosaur in this example, the user image data indicating the drawing 531 is extended and mapped also on the belly, the bottoms of the feet, and the inner surfaces of the left and right legs of the dinosaur.

FIG. 12C illustrates an example of a second user object 42b generated in this manner. The mapper 121 stores the second user object thus generated in the memory 1004, for example.

The method for mapping the user image data on the shape 41b is not limited to the foregoing example. For example, similarly to the method illustrated in FIG. 11B, two sets of the user image data indicating the drawing 531 may be respectively mapped on one and the other sides of the shape 41b. The mapping is preferably performed such that the user having viewed the second user object recognizes at least the use of the pattern created by the user in the drawing area 510.

In subsequent step S204, the action controller 124 of the image controller 101 sets initial coordinates of the first user object in the display area 50 at the time of display of the first user object in the image 13. The initial coordinates may be different for each of the first user objects, or may be common to the respective first user objects.

In subsequent step S205, the action controller 124 of the image controller 101 gives initial coordinates set in step S204 to the first user object to allow appearance of the first user object in the display area 50. As a result, the first user object is displayed in the image 13. In subsequent step S206, the action controller 124 of the image controller 101 causes a predetermined action (e.g., animation) of the first user object having appeared in the display area 50 in step S205.

In subsequent step S207, the action controller 124 of the image controller 101 allows appearance of the second user object in the display area 50. In this step, the action controller 124 sets initial coordinates of the second user object in the display area 50 in accordance with the coordinates of the first user object immediately before in the display area 50. For example, the action controller 124 designates, as initial coordinates of the second user object in the display area 50, coordinates of the first user object immediately before in the display area 50, or coordinates selected in a predetermined range for the corresponding coordinates. The action controller 124 thus switches the first user object to the second user object to allow appearance of the second user object in the display area 50.

In subsequent step S208, the action controller 124 of the image controller 101 causes a predetermined action of the second user object. Thereafter, the series of processes in the flowchart of FIG. 10 performed by the image controller 101 ends.

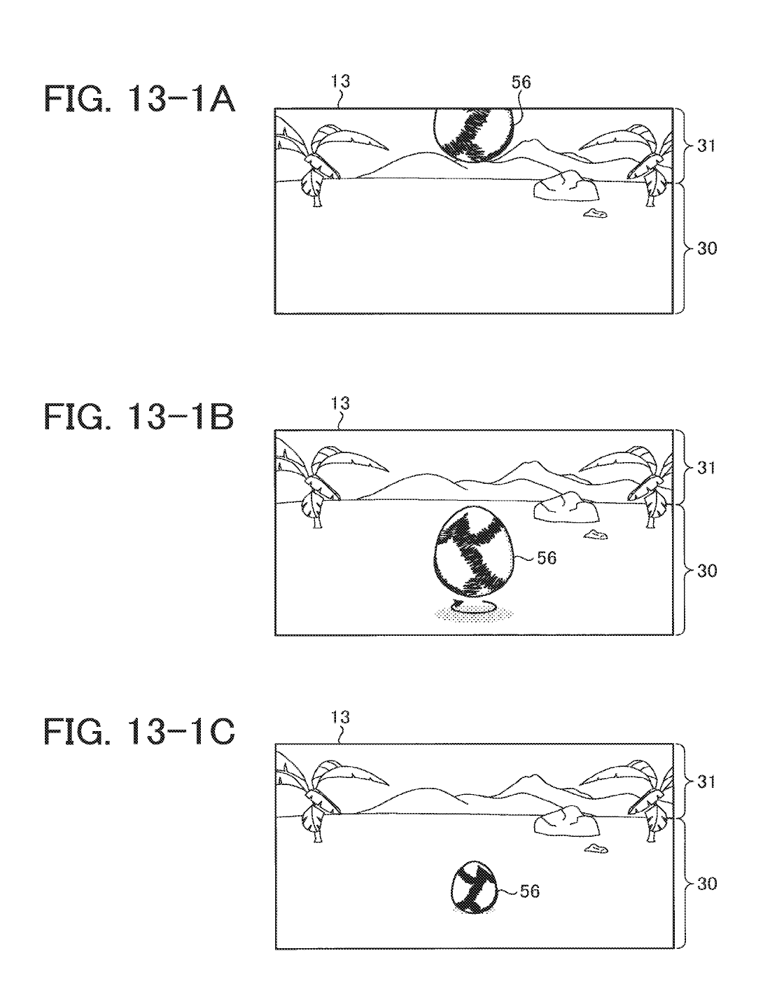

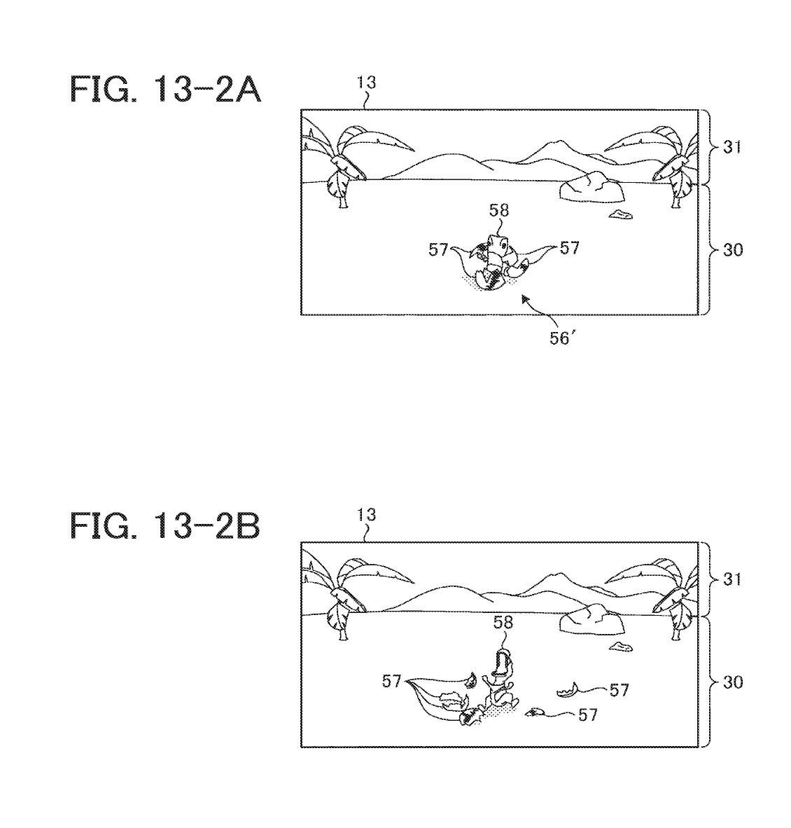

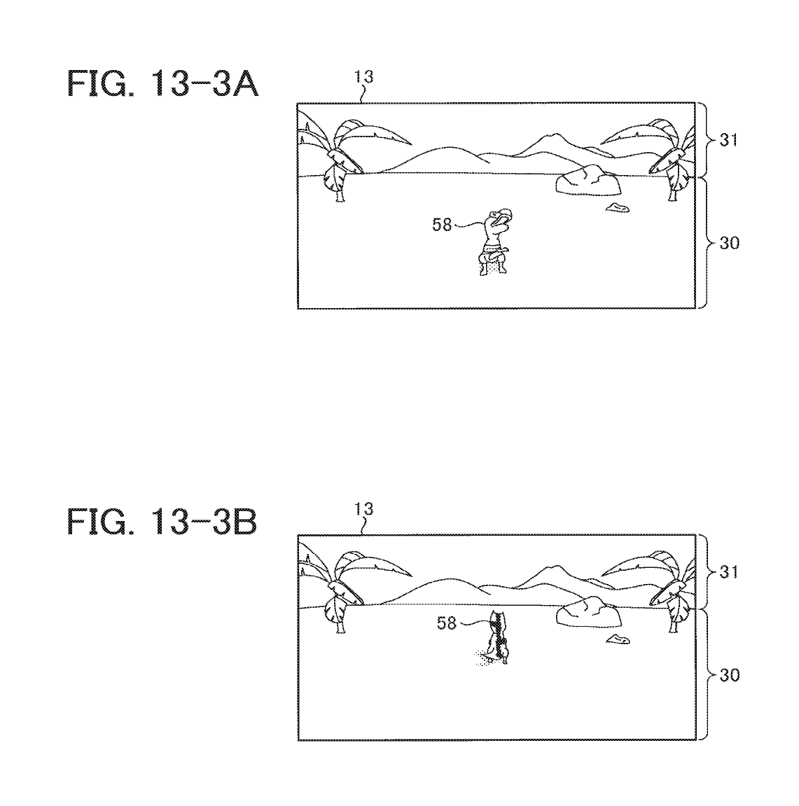

The processes in steps S205 through S207, and the process in a part of step S208 described above are further described in more detail with reference to FIGS. 13-1A through 13-3B. FIG. 13-1 illustrates an action example of the first user object at the time of appearance of the first user object in the display area 50 in steps S205 and S206 of FIG. 10.

For example, it is assumed in step S204 described above that the image controller 101 has given coordinates ((x₁−x₀)/2, y₁, z₀+r) to the first user object 56 as example initial coordinates (see FIGS. 5A through 5C). In this case, as illustrated in FIG. 13-1A by way of example, the first user object 56 appears in the image 13 from a central upper portion of the display area 50 on the front side.

It is assumed that the reference position of the first user object 56 is the center of gravity of the first user object 56, i.e., the center of gravity of the first shape, and that the value r is a radius of the first shape at the position of the center of gravity in the horizontal plane, for example.

According to this example, as illustrated in FIG. 13-1B, the action controller 124 of the image controller 101 shifts the first user object 56 having appeared in the image 13 toward the center of the image 13 within the display area 50. The action controller 124 maintains the first user object 56 at this position for a predetermined time while rotating the first user object 56 around the y axis. The action controller 124 may superimpose and display the image indicated by the title image data on a position corresponding to the first user object 56 in the state of FIG. 13-1B.

The action controller 124 of the image controller 101 further shifts the first user object 56 to the land area 30 as illustrated in FIG. 13-1C by way of example. More specifically, the action controller 124 gives coordinates (xₐ, y₀+h, zₐ) to the first user object 56. The value h herein indicates a height of the position of the center of gravity of the first shape described above, while the coordinates xₐ and zₐ are values randomly determined within the display area 50. The action controller 124 shifts the first user object 56 to the coordinates (xₐ, y₀+h, zₐ). According to the example of FIG. 13-1C, the first user object 56 shifts to a deeper position in the z axis direction based on a coordinate relationship of zₐ>z₀. Accordingly, the first user object 56 displayed in the image 13 is smaller in size than the first user object 56 displayed in FIG. 13-1B.

The process in step S207 and a part of the process in step S208 described above according to the first embodiment are described with reference to FIGS. 13-2A and 13-2B and FIGS. 13-3A and 13-3B. After maintaining the state illustrated in FIG. 13-1C for the predetermined time, the action controller 124 of the image controller 101 allows appearance of a second user object 58 in the display area 50 to display the second user object 58 within the image 13 as illustrated in FIG. 13-2A.

While maintaining the state illustrated in FIG. 13-1C for the predetermined time, the action controller 124 may cause a predetermined action of the first user object 56, such as an action expressing a sign of display of the second user object 58, for example. Possible actions for expressing this sign include vibration of the first user object 56, a change of the size of the first user object 56 in a predetermined cycle, for example.

In FIG. 13-2A, the action controller 124 allows appearance of the second user object 58 at the position of the first user object 56 immediately before the appearance, and switches the first user object 56 to the second user object 58 to display appearance of the second user object 58 in the display area 50. According to the example illustrated in FIG. 13-2A, broken piece objects 57 are scattered at the time of appearance of the second user object 58 to express a broken state of the egg shell represented by the first user object 56. For example, the broken piece objects 57 thus generated are predetermined divisions of the surface of the first user object 56 on which the user image data indicating the drawing 531 has been mapped.

Immediately after the appearance of the second user object 58 in the display area 50, the action controller 124 causes a predetermined action of the second user object 58 as illustrated in FIG. 13-2B. According to the example illustrated in FIG. 13-2B, the action controller 124 temporarily increases the value of the coordinate y of the second user object 58 to cause a jumping action of the second user object 58. In addition, according to the example illustrated in FIG. 13-2B, the action controller 124 causes an action of further scattering the broken piece objects 57 in the state illustrated in FIG. 13-2A in accordance with the action of the second user object 58.

Moreover, as illustrated in FIGS. 13-3A and 13-3B, the action controller 124 causes a predetermined action of the second user object 58 having appeared to express a state during a stop at the appearance position, and deletes the broken piece objects 57 (FIG. 13-3A). After this action, the action controller 124 shifts the second user object 58 in a random or a predetermined direction within the display area 50 based on the parameters (FIG. 13-3B).

As described above, according to the first embodiment, the display system 10 performs image processing for expressing a series of actions (animation) by mapping user image data indicating the handwritten drawing 531 created by the user to generate the first user object 56, switching the first user object 56 to the second user object 58 which is a user object on which the user image data indicating the drawing 531 is mapped, but has a shape different from the shape of the first user object 56, and displaying the second user object 58 in the image 13. Accordingly, the user is given an expectation about how the drawing 531 created by the user and corresponding to the first user object 56 is reflected in the second user object 58 having a shape different from the shape of the first user object 56.

Moreover, the second shape on which the second user object 58 is based is determined in accordance with an analysis result of the user image data indicating the drawing 531 created by the user. In this case, the user does not know which of the shapes 41a through 41d has been selected to express the second user object 58 until appearance of the second user object 58 within the display area 50. Accordingly, the user is given an expectation about appearance of the second user object 58.

For example, the processing illustrated in the flowchart of FIG. 10 may be repeated several times to display a plurality of the second user objects 58 in the display area 50 and allow appearance of the second user objects 58 in the image 13. For example, the processing illustrated in the flowchart of FIG. 6 is sequentially executed for a plurality of document images. A plurality of sets of user image data, and information and parameters indicating the second shape thus acquired are stored in the memory 1004. The image controller 101 executes the processing illustrated in the flowchart of FIG. 10 at a predetermined time or a random time. In step S201, the sets of the user image data, and the information and the parameters indicating the second shape stored in the processing illustrated in the flowchart of FIG. 6 are sequentially read to allow additional appearance of the second user object 58 in the display area 50 for each set read in this step.

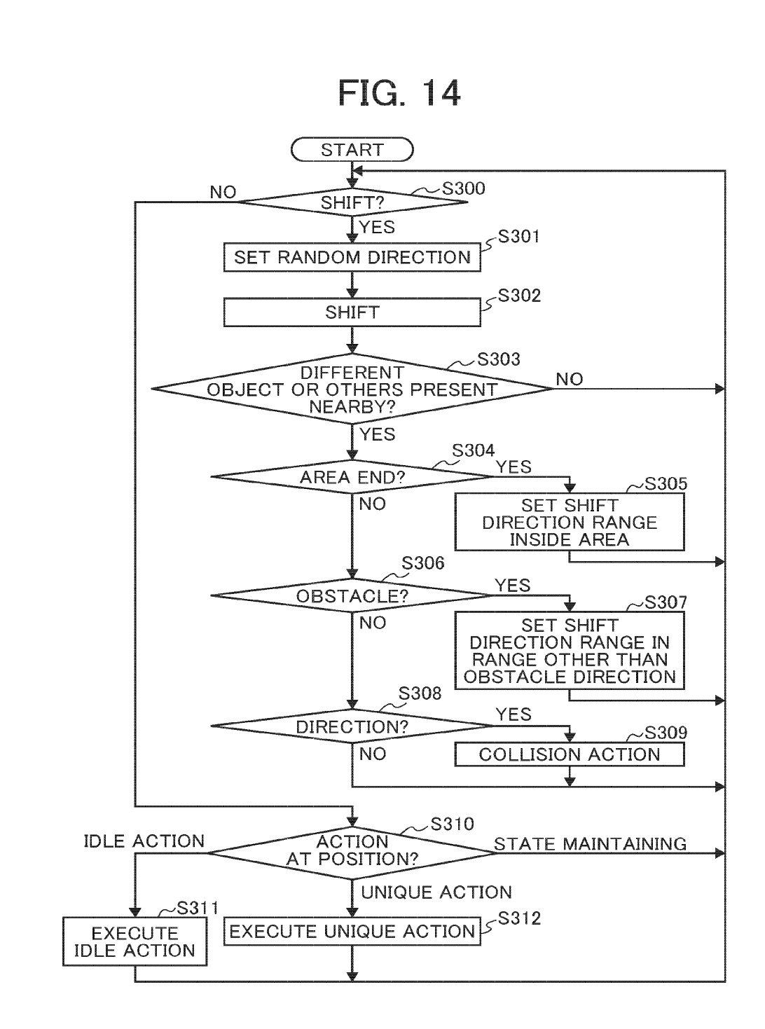

The process performed in step S208 in the flowchart illustrated in FIG. 10 according to the first embodiment is hereinafter described in more detail. FIG. 14 is a flowchart illustrating an example of a display control process performed when the second user object 58 in the display area 50 shifts in a normal mode according to the first embodiment. The action controller 124 of the image controller 101 executes the processing in the flowchart of FIG. 10 for each of the second user objects 58 corresponding to control targets. The normal mode herein is a state other than an event mode described below.

In step S300, the action controller 124 determines whether to shift the target second user object 58. For example, the action controller 124 randomly determines whether to shift the target second user object 58.

When the action controller 124 determines a shift of the target second user object 58 (“Yes” in step S300), the processing proceeds to step S301. In step S301, the action controller 124 randomly sets a shift direction of the target second user object 58 within the land area 30. In subsequent step S302, the action controller 124 causes an action of shift of the target second user object 58 to shift the corresponding second user object 58 in the direction set in step S301.

In this step, the action controller 124 controls the shift action based on the parameters generated in step S104 in FIG. 6. For example, the action controller 124 controls the shift speed of the second user object 58 during the shift in step S302 based on the parameters. More particularly, the action controller 124 determines the maximum speed, acceleration, and the speed of direction change of the second user object 58 during the shift based on the parameters. The action controller 124 shifts the second user object 58 with reference to these values determined in accordance with the parameters. In addition, the action controller 124 may determine whether to cause a shift in step S300 described above based on the parameters.

As described above, the parameters are generated by the parameter generator 120 based on an analysis result of the drawing 531 created by the user. Accordingly, the respective second user objects 58 having the second shape of the same type perform different actions when the drawing contents are not identical.

In subsequent step S303, the action controller 124 determines whether or not a different object or an end of the display area 50 corresponding to a determination target is present within a predetermined distance from the target second user object 58. When the action controller 124 determines that the determination target is absent within the predetermined distance (“No” in step S303), the processing returns to step S300.

The action controller 124 determines the distance from the different object based on the coordinates of the target second user object 58 and the coordinates of the different object in the display area 50. In addition, the action controller 124 determines the distance from the end of the display area 50 based on the coordinates of the target second user object 58 in the display area 50 and the coordinates of the end of the display area 50. The coordinates of the second user object 58 are determined based on the coordinates of the reference position corresponding to the center of gravity of the second user object 58, i.e., the second shape, for example.

When the action controller 124 determines that a determination target is present within the predetermined distance (“Yes” in step S303), the processing proceeds to step S304. In step S304, the action controller 124 determines whether or not the determination target present within the predetermined distance from the coordinates of the target second user object 58 is the end of the display area 50. More specifically, the action controller 124 determines whether the coordinates indicating the end of the display area 50 lie within the predetermined distance from the coordinates of the target second user object 58. When the action controller 124 determines that the end of the display area 50 is present within the predetermined distance (“Yes” in step S304), the processing proceeds to step S305.

In step S305, the action controller 124 sets a range of the shift direction of the target second user object 58 inside the display area 50. Thereafter, the processing returns to step S300.

When the action controller 124 determines that the determination target within the predetermined distance is not the end of the display area 50 in step S304 (“No” in step S304), the processing proceeds to step S306. When it is determined that the determination target is not the end of the display area 50 in step S304, it is considered that the determination target within the predetermined distance is a different object. Accordingly, the action controller 124 determines in step S306 whether the determination target within the predetermined distance from the target second user object 58 is an obstacle, i.e., any of the fixed objects 33 and 34.

Each of the fixed objects 33 and 34 is given identification information for indicating not a user object but as a fixed object to allow determination in step S306. Accordingly, the action controller 124 checks whether the identification information has been given to the different object present within the predetermined distance from the target second user object 58 to determine whether or not the different object within the predetermined distance is a fixed object.

When the action controller 124 determines that an obstacle is present within the predetermined distance (“Yes” in step S306), the processing proceeds to step S307. In step S307, the action controller 124 sets the range of the shift direction of the target second user object 58 within a range other than the direction toward the obstacle. Thereafter, the processing returns to step S300.

When the processing returns from step S305 or step S307 to step S300, the action controller 124 randomly determines the shift direction within the range set in step S305 or step S307 and cancels the range of the shift direction to set the shift direction of the target second user object 58 in step S301.

When the action controller 124 determines that the determination target within the predetermined distance is not an obstacle (“No” in step S306), the processing proceeds to step S308. In this case, it is determined that a different second user object is present within the predetermined distance from the target second user object 58.

In step S308, the action controller 124 determines the directions of the different second user object and the target second user object 58. More specifically, the action controller 124 determines whether or not the different second user object and the target second user object 58 face each other. Further specifically, the action controller 124 determines whether or not the traveling direction (vector) of the different second user object and the traveling direction (vector) of the target second user object 58 are substantially opposite directions, and are traveling directions to approach each other. When the action controller 124 determines that the two objects do not face each other (“No” in step S308), the processing returns to step S300.

Whether or not the directions of the two objects are substantially opposite in step S308 may be determined based on determination of whether or not the angle formed by the traveling direction of the one user object and the traveling direction of the other user object falls within a range from several degrees smaller than 180 degrees to several degrees larger than 180 degrees. The allowable range of the angle difference from 180 degrees may be appropriately determined. When the allowable range is excessively wide to a certain extent, a state of the two objects not apparently facing each other may be determined as a state facing each other. Accordingly, it is preferable that the allowable range of the angle difference from 180 degrees is set to an appropriate value of five degrees or ten degrees from 180 degrees, for example, to define a smaller range.

On the other hand, when the action controller 124 determines in step S308 that the two objects face each other (“Yes” in step S308), the processing proceeds to step S309. In this case, a different second user object 50 and the target second user object 58 may collide with each other when the different second user object 50 and the target second user object 58 keep shifting in this state, for example. In step S309, the action controller 124 causes collision actions of the different second user object 50 and the target second user object 58. When the collision actions of the different second user object 50 and the target second user object 58 end, the action controller 124 changes the traveling directions of the two user objects to different directions not to face each other. Thereafter, the processing returns to step S300.

When the action controller 124 determines not to shift the target second user object 58 in step S300 described above (“No” in step S300), the processing proceeds to step S310. In this stage, the target second user object 58 stops shifting and stays at the same position. In step S310, the action controller 124 determines the action of the target second user object 58 at the position. According to this example, the action controller 124 selects any one of an idle action, a unique action, and a state maintaining action, and designates the selected action as the action of the target second user object 58 at the position.

When the action controller 124 selects the idle action as the action of the target second user object 58 at the position (“Idle action” in step S310), the processing proceeds to step S311. In this case, the action controller 124 causes a predetermined idle action of the target second user object 58. Thereafter, the processing returns to step S300.

The action controller 124 may make the respective determinations in steps S304, S306, and S308 described above based on different reference distances.

When the action controller 124 selects the unique action as the action of the target second user object 58 at the position (“Unique action” in step S310), the processing proceeds to step S312. In step S312, the action controller 124 causes a unique action of the target second user object 58 as an action prepared beforehand in accordance with types of the target second user object 58. Thereafter, the processing returns to step S300.

When the action controller 124 selects the state maintaining action as the action of the target second user object 58 at the position (“State maintaining” in step S310), the action controller 124 maintains the current action of the target second user object 58. Thereafter, the processing returns to step S300.

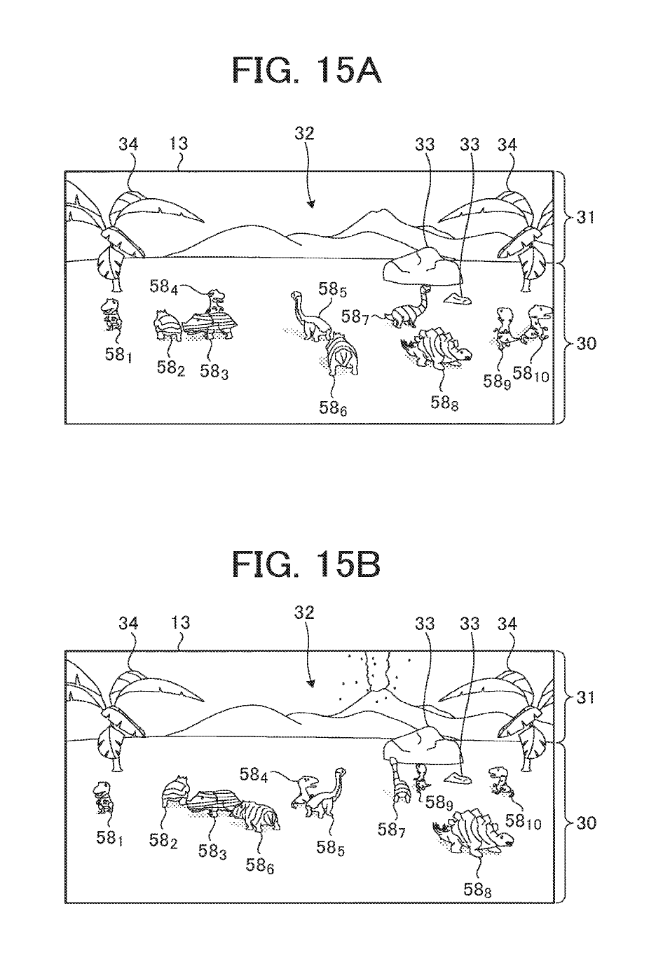

FIGS. 15A and 15B are schematic views illustrating shifts of the plurality of second user objects 58 in the display area 50 in the state that the respective actions are controlled as described above according to the first embodiment. FIG. 15A illustrates an example of the plurality of second user objects 58₁ through 58₁₀ appearing in the display area 50, and display of the plurality of second user objects 58₁ through 58₁₀ in the image 13 at a certain time. It is assumed, for example, that sets of user image data each indicating corresponding one of the drawings 531 different from each other are mapped on the corresponding shapes 41a through 41d provided as the second shapes to generate the plurality of second user objects 58₁ through 58₁₀.

FIG. 15B illustrates an example of display of the image 13 after an elapse of a predetermined time (e.g., several seconds) from the state illustrated in FIG. 15A. For each of the second user objects 58₁ through 58₁₀, whether to shift is randomly determined in step S300, and the shift direction is further determined by the action controller 124 in step S301. Accordingly, the respective second user objects 58₁ through 58₁₀ move around in the display area 50 without relevance to each other.

For example, the second user object 58₂ shifts to a deeper position in the display area 50, while the second user object 58₃ stays at the same position. On the other hand, the second user object 58₅ changes the shift direction from the left direction to the right direction, while the second user object 58₇ changes the shift direction from the right direction to the depth direction. In addition, for example, the second user objects 58₉ and 58₁₀ located close to each other in FIG. 15A are shifted to positions deeper and away from each other in the display area 50 in FIG. 15B.

According to this example, the respective second user objects 58₁ through 58₁₀ have shapes representing dinosaurs, and shift without relevance to each other as described above to achieve more natural expressions.

During execution of the display control for the second user objects 58₁ through 58₁₀ in this manner, execution of the appearance process of the first user object 56 and the second user object 58 into the display area 50 as described with reference to FIG. 10 continues. Accordingly, the image 13 simultaneously displays actions of the one or more second user objects 58₁ through 58₁₀ described with reference to FIGS. 15A and 15B, and appearance of the first user object 56, and switching from the first user object 56 to the second user object 58 to allow appearance of the second user object 58 as described with reference to FIGS. 13-1A through 13-3B.

### Display Control Process for Event Display in First Embodiment

A display control process for event display according to the first embodiment is hereinafter described. According to the first embodiment, the image controller 101 is capable of causing an event in a state that the one or more second user objects 58₁ through 58₁₀ illustrated in FIG. 15A and other figures are displayed, for example. The image controller 101 causes an event at a predetermined time or at a random time.

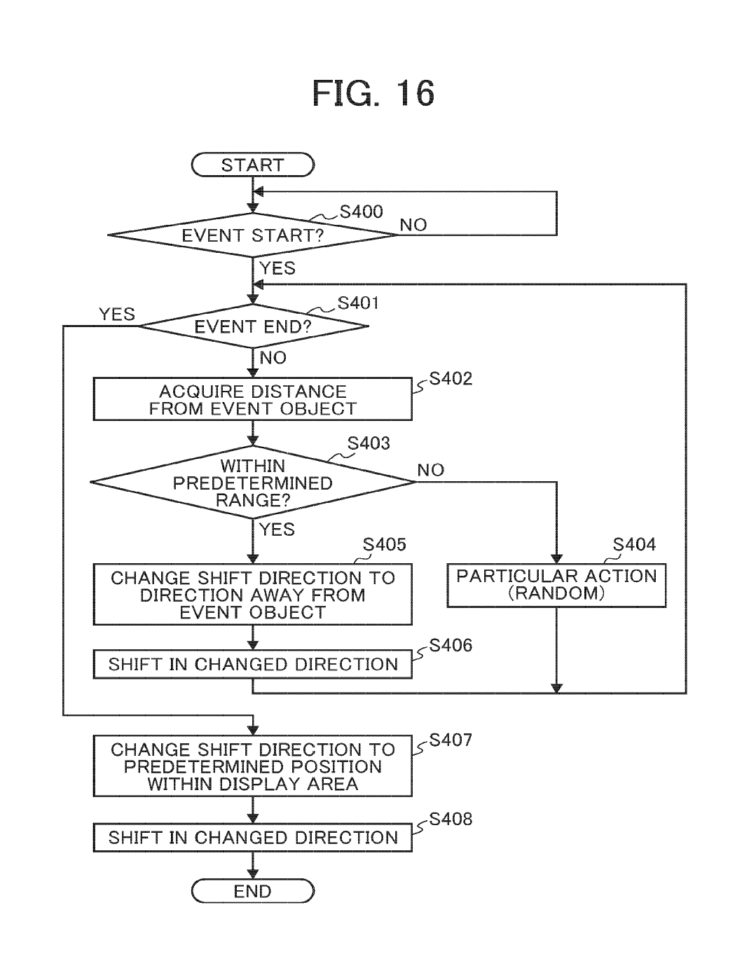

Event display according to the first embodiment is hereinafter described with reference to FIG. 16 and FIGS. 17-1 through 17-3. FIG. 16 is a flowchart illustrating an example of an event display process according to the first embodiment. FIGS. 17-1, 17-2A and 17-2B, and 17-3 illustrate an example of the image 13 at the time of event display in a time-series order according to the first embodiment.

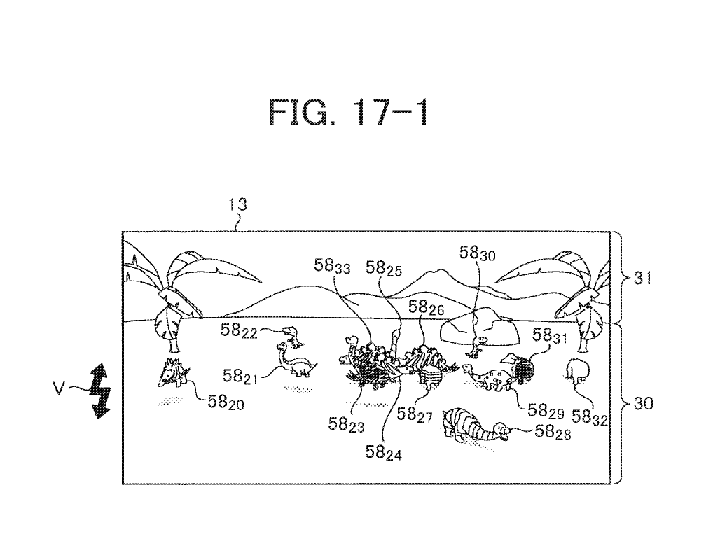

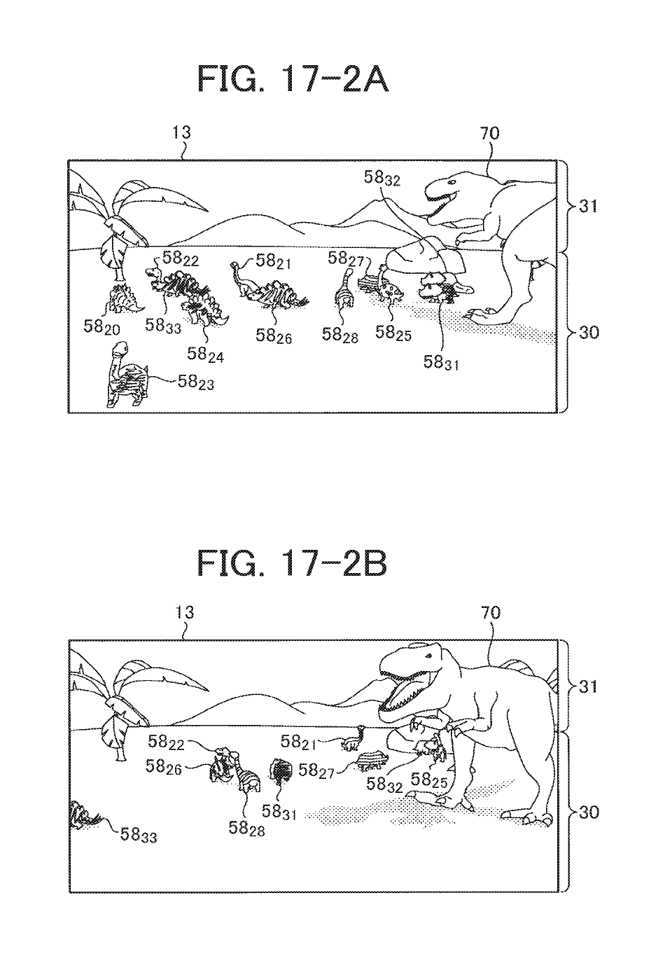

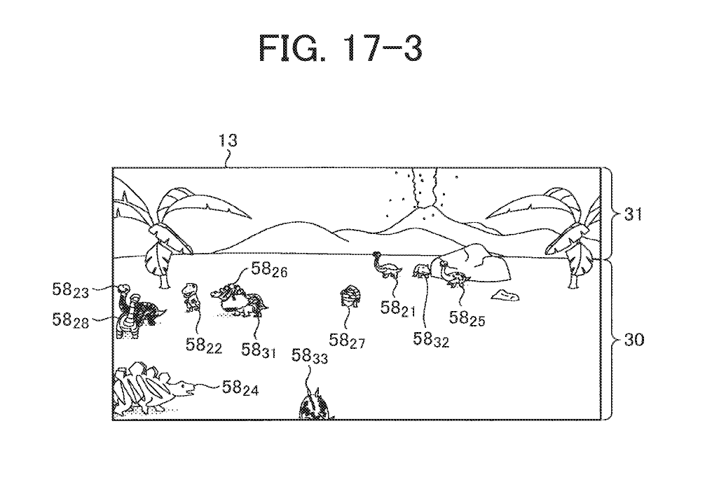

For example, as illustrated in FIGS. 17-2A and 17-2B, the image controller 101 causes an event of appearance of a larger event object 70 (third image) than each of the second user objects 58. According to the example illustrated in FIGS. 17-2A and 17-2B, it is assumed that the event object 70 has a height several times larger than the height of each of the second user objects 58. In this example, the event includes a sign action of appearance of the event object 70 into the display area 50, and a shift of the event object 70 within the display area 50 after appearance of the event object 70 in the display area 50. The respective actions of the second user objects 58 change in accordance with occurrence of the event.

The event display process according to the first embodiment is now described with reference to the flowchart illustrated in FIG. 16. The action controller 124 of the image controller 101 executes the process illustrated in the flowchart of FIG. 16 for each of the control target second user objects.

In step S400, the action controller 124 of the image controller 101 determines whether or not an event has occurred. In this stage, each of the respective second user objects 58 acts in the normal mode described with reference to FIG. 14. When the action controller 124 determines that no event has occurred (“No” in step S400), the processing returns to step S400. On the other hand, when the action controller 124 determines that an event has occurred (“Yes” in step S400), the processing proceeds to step S401.

In step S401, the action controller 124 determines whether or not the event has ended. When the action controller 124 determines that the event has not ended yet (“No” in step S401), the processing proceeds to step S402.

In step S402, the action controller 124 acquires a distance between the target second user object 58 and the event object 70. Before appearance of the event object 70 in the display area 50, a distance indicating infinity is acquired in this step, for example. The event object 70 is given identification information indicating that the event object 70 is an event object. In subsequent step S403, the action controller 124 determines whether or not the acquired distance is a predetermined distance or shorter. When the action controller 124 determines that the distance is not the predetermined distance or shorter (“No” in step S403), the processing proceeds to step S404.

In step S404, the action controller 124 causes a particular action of the target second user object 58 at a predetermined time. In this case, the action controller 124 may randomly determine whether to cause the particular action of the target second user object 58. For example, the particular action is a jump action of the target second user object 58. After completion of the particular action (or when determined not to cause particular action), the action such as shift and stop continues in the normal mode.

The particular action is not limited to a jump action. For example, the particular action may be a rotational action of the target second user object 58 at that spot, or display of a certain message in the vicinity of the target second user object 58. Alternatively, the particular action may be a temporary change of the shape of the target second user object 58 into another shape, or a change of the color of the target second user object 58. Alternatively, the particular action may be a temporary display of a different object indicating a state of mind or a condition of the target second user object 58 (e.g., object indicating sweat marks) in the vicinity of the target second user object 58.

FIG. 17-1 schematically illustrates a state of particular actions randomly performed by the second user objects 58₂₀ through 58₃₃ in the display area 50. According to the example illustrated in FIG. 17-1, it is apparent that the second user objects 58₂₀, 58₂₁, and 58₂₃ are jumping based on relationships between the respective second user objects 58₂₀, 58₂₁, and 58₂₃ and shadows in the land area 30 (longer distances between these second user objects and shadows than corresponding distances between not jumping other second user objects 58₂₈, 58₂₉ and the like and shadows). Moreover, according to this example, a vibrating effect in the up-down direction is given to the display of the display area 50 within the image 13 as indicated by an arrow V in the figure at predetermined time intervals. The jumping actions are performed in accordance with the time of the vibrations.

After the action controller 124 completes the particular actions in step S404, the processing returns to step S401.

When the action controller 124 in step S403 determines that the distance from the event object 70 is a predetermined distance or shorter (“Yes” in step S403), the processing proceeds to step S405. In step S405, the action controller 124 switches the action mode of the target second user object 58 from the normal mode to an event mode. In the event mode, not the actions of the normal mode but the actions of the event mode are performed in the action process for the event mode. Before an end of the event in the operation process for the event mode, the shift direction is changed to a direction away from the event object 70, while the shift speed is increased to twice higher than the maximum speed set based on parameters. In subsequent step S406, the action controller 124 regularly repeats determination of whether or not the event has ended, and continues the shift of the target second user object 58 at the speed and in the direction set in step S405 until determination of an end of the event.

FIG. 17-2A illustrates an example of appearance of the event object 70 in the display area 50 in the state illustrated in FIG. 17-1 described above, while FIG. 17-2B illustrates an example of a state of a shift of the event object 70 after a further elapse of time from the state illustrated in FIG. 17-2A. An appearance position and a shift route of the event object 70 in the display area 50 may be determined beforehand, or randomly determined for each occurrence of an event.

In FIG. 17-2A, the event object 70 appears into the display area 50 from the right end side of the display area 50. It is apparent that each of the second user objects 58₂₀ through 58₃₃ in FIG. 17-2A shifts toward the left, depth, or other directions of the display area 50 from the respective positions illustrated in FIG. 17-1 in accordance with the appearance of the event object 70. With a shift of the event object 70 within the display area 50 after an elapse of time from the state illustrated in FIG. 17-2A, the respective second user objects 58₂₀ through 58₃₃ within the display area 50 shift to positions further away from the event object 70 as illustrated in FIG. 17-2B in accordance with the elapse of time and the shift of the event object 70.

Even in the event mode, the actions for avoiding different objects continue when the different objects are present nearby as described with reference to FIG. 14. However, in the event mode, the actions are performed in such a manner as to avoid both fixed objects and second user objects as different objects. More specifically, in the event mode, the determination of whether or not the facing different object is a different second user object, and the collision action as described in step S308 and step S309 in FIG. 14 are not performed. In addition, while whether or not an obstacle, i.e., a fixed object is present within the predetermined distance is determined in step S304 in FIG. 14, the process in step S307 in the event mode is performed for both a fixed object and a different second user object. Accordingly, whether or not the object present within the predetermined distance is a fixed object need not be determined.

Moreover, in the event mode, the action controller 124 controls (extends) the shift range to allow shifts of the respective second user objects 58₂₀ through 58₃₃ to the non-display areas 51a and 51b described with reference to FIG. 5B. In this case, the second user objects are allowed to shift beyond the display area 50 displaying the event object. Expressed accordingly is such a state that the respective second user objects escape from the event object 70 and disappear from the screen.

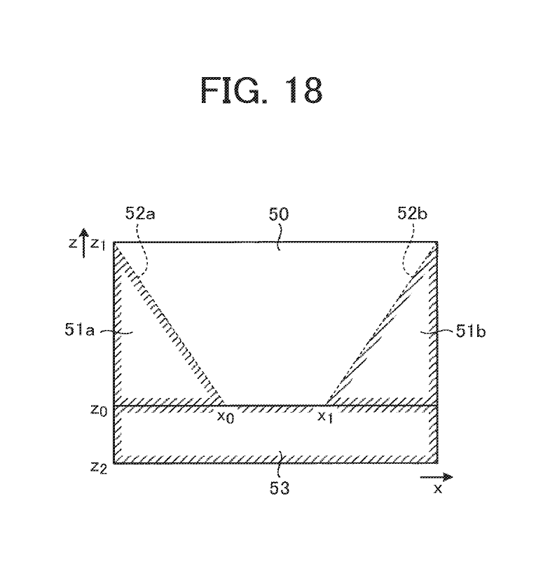

Furthermore, the display area setter 123 of the image controller 101 is capable of extending an area defined by coordinates. FIG. 18 illustrates an example of an area extended to a coordinate z₂ in the z axis direction on the front side with respect to the coordinate z₀ according to the first embodiment. An area 53 in a range extending from the coordinate z₀ to the coordinate z₂ is a non-display area not displayed in the image 13 (hereinafter referred to as non-display area 53). In the event mode, the action controller 124 is capable of shifting the respective second user objects 58₂₀ through 58₃₃ to the extended non-display area 53.

As described in steps S304 and S305 with reference to FIG. 14, in the normal mode, the action controller 124 performs control such that the second user objects 58 do not shift beyond the display area 50 and disappear from the display area 50. A process deleting the old second user objects 58 from the display area 50 may be performed when the number of the second user objects exceeds a predetermined limit number within the display area 50. However, this process is controlled such that the second user object 58 corresponding to a display target does not disappear from the display area 50. Accordingly, the action controller 124 defines a shift area of the second user object 58 inside the display area 50, determines whether the second user object 58 reaches the end of the shift area (whether end of display area 50 approaches predetermined distance), and changes the direction of the second user object 58 to make a turn when the second user object 58 reaches the end. On the other hand, in the event mode, the action controller 124 defines a shift area including the non-display area not displayed in the image 13. Accordingly, the second user object 58 is allowed to shift to the outside of the display area 50 while continuing the same action without a turn of the shift of the second user object 58 even when the second user object 58 reaches the end of the display area 50.

According to the example illustrated in FIG. 17-2B, the image 13 does not include display of the second user objects 58₂₃, 58₂₄, 58₂₉, and 58₃₀ included in the second user objects 58₂₀ through 58₃₃ having been present in the display area 50 in FIG. 17-1. It is considered that the respective second user objects 58₂₃, 58₂₄, 58₂₉, and 58₃₀ have shifted to the non-display areas 51a, 51b, and 53. In addition, it is apparent from FIG. 17-2B that the second user object 58₃₃ located at the left end is shifting toward the non-display area 51a.

In the event mode, the action controller 124 may control the actions of the second user objects 58 having shifted to the outside of the display area 50 such that the corresponding second user objects do not return into the display area 50 until the end of the event. When it is determined that the event has not ended yet under this action control, the action controller 124 performs event mode action control for determining whether or not the second user object 58 is present in the non-display area 51a, 51b, or 53, and whether or not the end of the display area 50 lies within the predetermined distance. When it is determined that the second user object 58 is present in the non-display area 51a, 51b, or 53, and that the end of the display area 50 is present within the predetermined distance, the action controller 124 changes the shift direction of the second user object 58 to make a turn and avoid entrance into the display area 50.

When the action controller 124 determines in step S401 described above that the event has ended (“Yes” in step S401), the processing proceeds to step S407. In step S407, the action controller 124 changes the shift direction of the target second user object 58 having shifted to the outside of the display area 50, i.e., to the non-display area, to a direction toward a predetermined position inside the display area 50. In this case, the action controller 124 may change the shift direction to a direction toward a predetermined position corresponding to the position of the target second user object 58 immediately before occurrence of the event. Alternatively, the action controller 124 may change the shift direction to a direction toward a predetermined position corresponding to another position inside the display area 50, such as a randomly selected position inside the display area 50.

In subsequent step S408, the action controller 124 shifts the target second user object 58 in the direction changed in step S407, and checks whether or not the coordinates of the target second user object 58 are included in the display area 50 (whether second user object 58 has returned into display area 50). When it is confirmed that the target second user object 58 has returned into the display area 50, the action controller 124 switches the event mode to the normal mode. The respective actions of the second user objects having returned into the display area 50 in this manner return to the actions in the normal mode described with reference to FIG. 14 until a start of a next event. However, for the second user objects located inside the display area 50 without shifting to the non-display area at the time of determination of the end of the event, the action mode is switched from the event mode to the normal mode without performing the processes in steps S407 and S408.

FIG. 17-3 illustrates a state of shifts of the respective second user objects 58₂₀ through 58₃₃ in the shift directions changed in step S407 after the end of the event. In addition, the second user objects 58₂₃, 58₂₄, 58₃₃ and others having shifted into any of the non-display areas 51a, 51b, and 53 return into the display area 50. When the event ends, the states of the respective second user objects 58₂₀ through 58₃₃ inside the display area 50 gradually return to the states before occurrence of the event in the manner described above.

According to the first embodiment, therefore, actions of the respective second user objects 58₂₀ through 58₃₃ present in the display area 50 are allowed to change in accordance with an event having occurred. Accordingly, the actions of the second user objects generated based on the drawing 531 created by the user become more sophisticated actions, and further attract curiosity and concern from the user.

### Action Features of Respective Shapes in First Embodiment

Action features of the plurality of types of the second shapes according to the first embodiment are hereinafter described. In the first embodiment, action features are set beforehand for each of the plurality of types of second shapes, and for each of one or more actions set beforehand for each of the second shapes. Table 1 lists examples of action features set for each of the second shapes representing the respective dinosaur shapes illustrated in FIGS. 9A through 9D.

TABLE 1

| | MODEL | IDLE ACTION | GESTURE | BATTLE MODE |
|---|---|---|---|---|
| DINOSAUR | TYRANNOSAURUS | BREATHING WITH | SHAKING | OPENING MOUTH |
| #1 | | VERTICAL MOVEMENT | HEAD | AND SWINGING |
| | | AND NO SHIFT | | BODY |
| DINOSAUR | TRICERATOPS | BREATHING WITH | STRETCHING | THREATENING |
| #2 | | VERTICAL MOVEMENT | BODY AND | AND RUSHING |
| | | AND NO SHIFT | WAGGING | |
| | | | TAIL | |
| DINOSAUR | STEGOSAURUS | BREATHING WITH | SWINGING | OPENING MOUTH |
| #3 | | VERTICAL MOVEMENT | BODY | AND SWINGING |
| | | AND NO SHIFT | | BODY |
| DINOSAUR | BRACHIOSAURUS | BREATHING WITH | SHAKING | RAISING FRONT |
| #4 | | VERTICAL MOVEMENT | HEAD | LEG AND |
| | | AND NO SHIFT | | THREATENING |

Each line in Table 1 indicates corresponding one of the plurality of second shapes (dinosaurs #1 through #4), and includes items of “model”, “idle action”, “gesture”, and “battle mode”. It is assumed that the second shapes of the respective dinosaurs #1 through #4 correspond to the shapes 41a, 41b, 41c, and 41d described with reference to FIGS. 9A through 9D, respectively.

The item “model” in Table 1 indicates the name of the dinosaur represented (modeled) by the second shape in the corresponding line. The item “idle action” indicates an action of the second shape in the corresponding line in a not shifting state (stop state). This action corresponds to the idle action in step S311 of the flowchart of FIG. 14. According to this example, “breathing with vertical movement and no shift” is set for each of the second shapes.

The item “gesture” corresponds to the unique action in step S312 in the flowchart of FIG. 14. According to this example, “shaking head” is set for the dinosaurs #1 and #4, “stretching body and wagging tail” is set for the dinosaur #2, and “swinging body” is set for the dinosaur #3.

The item “battle mode” corresponds to the collision action in step S309 in the flowchart of FIG. 14. According to the second shapes representing dinosaurs in this example, it is assumed that the collision actions represent battles between dinosaurs. According to this example, “opening mouth and swinging body” is set for the dinosaurs #1 and #3, “threatening and rushing” is set for the dinosaur #2, and “raising front leg and threatening” is set for the dinosaur #4 in the item of “battle mode”.

The settings of the respective items for the dinosaurs #1 through #4 in Table 1, and basic action patterns of the respective models are more specifically described with reference to FIGS. 19-1A and 19-1B and 19-2, FIGS. 20-1A and 20-1B and FIG. 20-2, FIGS. 21-1A and 21-1B and 21-2, and FIGS. 22-1A and 22-1B and 22-2.

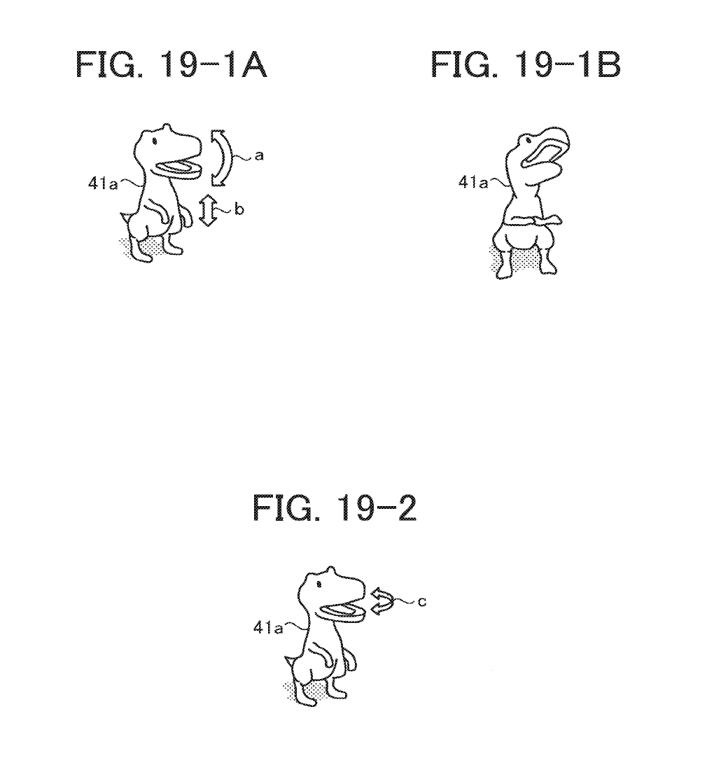

FIGS. 19-1A and 19-1B and 19-2 illustrate an example of settings of respective items for the dinosaur #1 according to the first embodiment. The dinosaur #1 has the second shape corresponding to the shape 41a illustrated in FIG. 9A. FIGS. 19-1A and 19-1B illustrate an example of the action corresponding to the setting of the item “idle action”. As illustrated in FIG. 19-1A, the action controller 124 causes an upward and downward movement of a part representing the head of the dinosaur #1 having the shape 41a as indicated by an arrow a, and also causes an upward and downward shaking movement of the whole body of the shape 41a as indicated by an arrow b. This manner of movement expresses “breathing with vertical movement and no shift” of the item “idle action” of the shape 41a. The movement indicated by the arrow b is practically achieved by expanding and contracting parts corresponding to joints of the shape 41a, for example, to express an upward and downward shaking movement of the whole body. The action controller 124 causes an animation action by repeating the states of the movements of the shape 41a as indicated by the arrows a and b in FIGS. 19-1A and 19-1B to express the idle action.

FIG. 19-2 illustrates an example of the action corresponding to the setting of the item “gesture”. According to Table 1, “shaking head” is set for the item “gesture”. According to this example, the action controller 124 causes an animation action for shaking the part representing the head of the shape 41a in the horizontal direction as indicated by an arrow c to express the unique action “shaking head”.

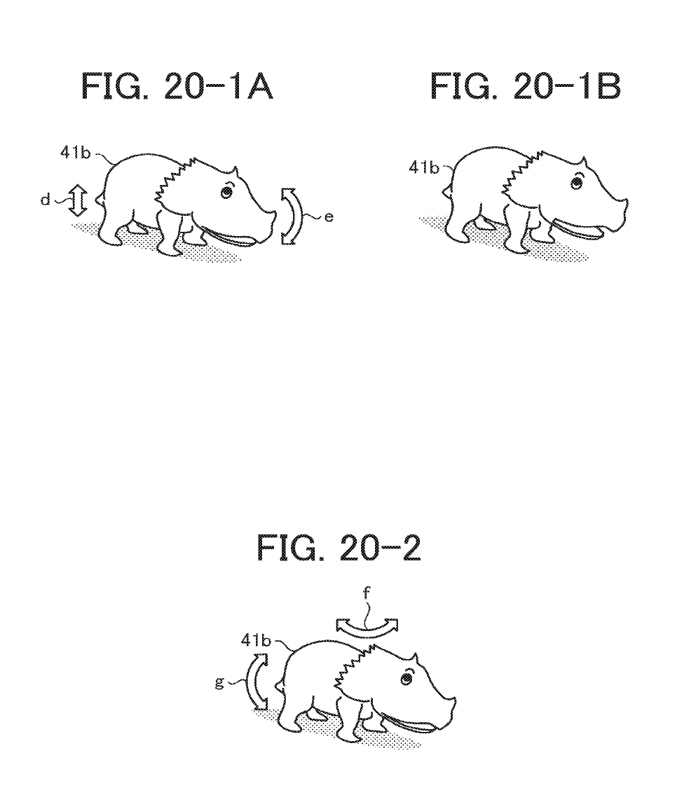

FIGS. 20-1A and 20-1B and FIG. 20-2 illustrate an example of settings of respective items for the dinosaur #2 according to the first embodiment. The dinosaur #2 has the second shape corresponding to the shape 41b illustrated in FIG. 9B. FIGS. 20-1A and 20-1B illustrate an example of the action corresponding to the setting of the item “idle action”. As illustrated in FIG. 20-1A, the action controller 124 causes an upward and downward movement of a part representing the head of the dinosaur #2 having the shape 41b as indicated by an arrow e, and also causes an upward and downward shaking movement of the whole body of the shape 41b as indicated by an arrow d. This manner of movement expresses “breathing with vertical movement and no shift” of the item “idle action” of the shape 41b. The action controller 124 causes an animation action for repeating the states of the movements of the shape 41b as indicated by the arrows d and e in FIGS. 20-1A and 20-1B to express the idle action.

FIG. 20-2 illustrates an example of the action corresponding to the setting of the item “gesture”. According to Table 1, “stretching body and wagging tail” is set for the item “gesture”. According to this example, the action controller 124 causes an animation action which includes an action of stretching the whole body upward in the facing direction of the shape 41b as indicated by an arrow f, and an upward and downward reciprocating action of the part representing the tail in the tail portion of the shape 41b as indicated by an arrow g to express the unique action “stretching body and wagging tail”.

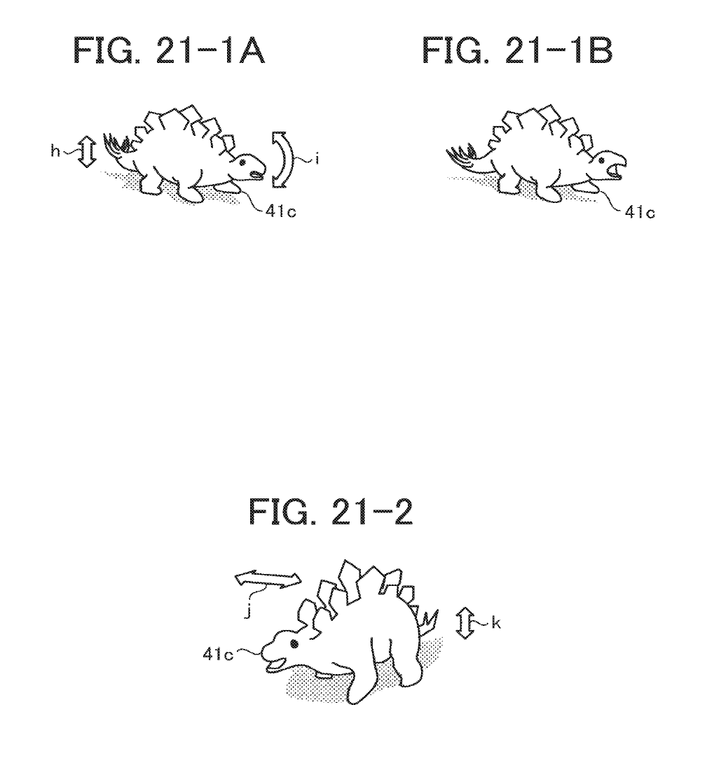

FIGS. 21-1A and 21-1B and FIG. 21-2 illustrate an example of settings of respective items for the dinosaur #3 according to the first embodiment. The dinosaur #3 has the second shape corresponding to the shape 41c illustrated in FIG. 9C. FIGS. 21-1A and 21-1B illustrate an example of the action corresponding to the setting of the item “idle action”. As illustrated in FIG. 21-1A, the action controller 124 causes an animation action which includes an upward and downward movement of a part representing the head of the dinosaur #3 having the shape 41c as indicated by an arrow i, and an upward and downward shaking movement of the whole body of the shape 41c as indicated by an arrow h. This manner of movement expresses “breathing with vertical movement and no shift” of the item “idle action” of the shape 41c. The action controller 124 causes an animation action for repeating states of the movements of the shape 41c as indicated by the arrows h and i in FIGS. 21-1A and 21-1B to express the idle action.

FIG. 21-2 illustrates an example of the action corresponding to the setting of the item “gesture”. According to Table 1, “swinging body” is set for the item “gesture”. According to this example, the action controller 124 causes an animation action which includes a swinging action of the shape 41c in a direction perpendicular to the facing direction as indicated by an arrow j, and an upward and downward swinging action of the whole body of the shape 41c as indicated by an arrow k to express the unique action “swinging body”.

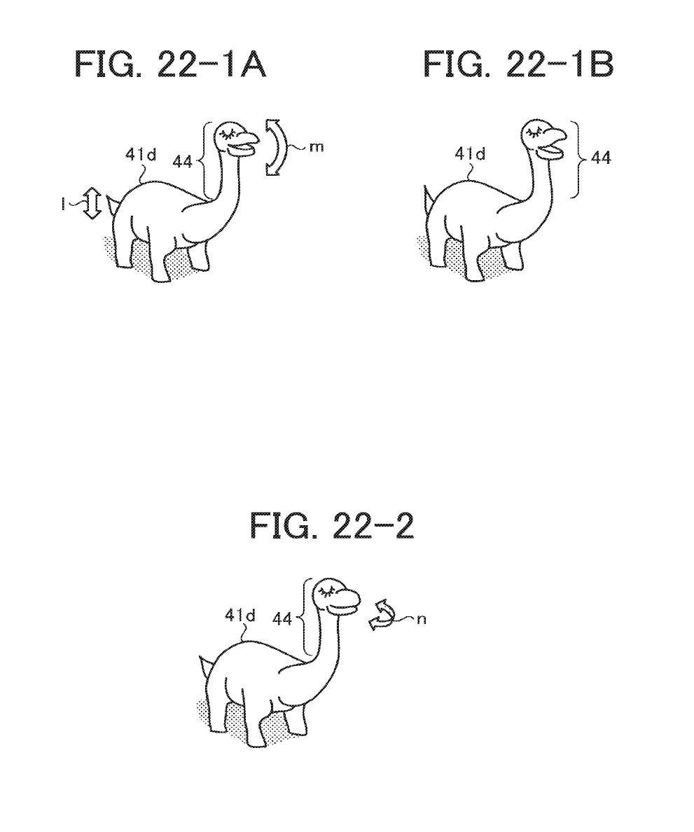

FIGS. 22-1A and 22-1B and FIG. 22-2 illustrate an example of settings of respective items for the dinosaur #4 according to the first embodiment. The dinosaur #4 has the second shape corresponding to the shape 41d illustrated in FIG. 9D. FIGS. 22-1A and 22-1B illustrate an example of the action corresponding to the setting of the item “idle action”. As illustrated in FIG. 22-1A, the action controller 124 causes an animation action which includes an upward and downward movement of a part 44 representing the neck and the head included in a part representing the head part of the dinosaur #4 having the shape 41d as indicated by an arrow m, and an upward and downward shaking movement of the whole body of the shape 41d as indicated by an arrow l. The action controller 124 expresses “breathing with vertical movement and no shift” of the item “idle action” in this manner. The action controller 124 causes an animation action for repeating the states of the movements of the shape 41d as indicated by the arrows m and l in FIGS. 22-1A and 22-1B to express the idle action.

FIG. 22-2 illustrates an example of the action corresponding to the setting of the item “gesture”. According to Table 1, “shaking head” is set for the item “gesture”. According to this example, the action controller 124 causes an animation action which includes a leftward and rightward shaking action of a part representing the neck and the head of the shape 41d as indicated by an arrow n to express the unique action “shaking head”.

The parameters generated based on the user image data in step S104 in FIG. 6 may be reflected in the foregoing basic action patterns set for each of the models (types of second shape).

For example, the action controller 124 may set a movement width (arrows a and b in example of FIG. 19-1A), and movement speed and timing (time interval) for the idle actions based on the parameters. Moreover, the action controller 124 may set a step and a walking speed of a walking action, and a jump height of an appearance action based on the parameters.

Accordingly, the respective actions of the shapes 41a through 41d are controllable based on the parameters corresponding to the user image data. Accordingly, the respective basic actions of the second user objects even having the same shape do not become completely the same actions, but express uniqueness in accordance with differences of the drawing contents.

According to the above description, the second user object 58 appears in the display area 50 after display of the first user object 56 on the assumption that the first shape of the first user object 56 represents an egg shape, and that the second shape of the second user object 58 represents a dinosaur shape. However, other examples may be adopted. More specifically, the first shape and the second shape applicable to the display system 1 according to the first embodiment may be other shapes as long as the first shape and the second shape are different shapes.

For example, the first shape and the second shape may be shapes representing objects having different shapes but relevant to each other. More specifically, the first shape may represent an egg as described above, while the second shape may represent a creature hatching from an egg (e.g., birds, fishes, insects, and amphibians), for example. In this case, the creature hatching from the egg may be an imaginary creature.

The first shape and the second shape relevant to each other may be shapes of humans. For example, the first shape may represent a child, while the second shape may represent an adult. Alternatively, the first shape and the second shape may represent completely different appearances of humans.

Here, a person viewing the two shapes finds relevance between the shapes. This relevance depends on the types of information given to the user from his or her environment, such as educations, cultures, arts, and entertainments. Broad and general information in a community such as a country and a region is adoptable when the display system 1 of the present embodiment provides services for the community. For example, relevance between a “frog” and a “tadpole” in a growth process may be knowledge shared by many countries. In addition, a “viper” and a “mongoose” may be relevant two types of creatures in Japan or at least in Okinawa district, a region of Japan. Furthermore, for example, the first shape may be a character appearing in an animation of popular hero video content or battle video content (e.g., movie, TV-broadcasted animation and drama) in a certain region. In this case, the second shape may be a transformed appearance of the character.

As apparent from the above description, the first shape and the second shape relevant to each other are not limited to shapes of creatures. One or both of the first shape and the second shape may be an inanimate object. For example, there has been video content which shows a vehicle, an airplane or other types of vehicle transformable into a human-shaped robot which has parts representing face, body, arms, and legs of a human. In this case, the first shape may represent a car, while the second shape may represent a robot as a shape transformed from the car represented by the first shape. Furthermore, the first shape and the second shape may represent objects having different shapes and not relevant to each other as long as the respective shapes attract interest and concern from the user.

According to the example of the first shape and the second shape representing an egg and a dinosaur, respectively, actions are controlled such that an appearance scene of a dinosaur hatching from an egg is displayed, and that the hatched dinosaur shifts in the display area 50 after hatching. This example is presented in consideration that a dinosaur is a target associated with a mobile body, and that an egg is not associated with a mobile body. When the first shape and the second shape are not an egg and a dinosaur, but a vehicle and a human-shaped robot, respectively, for example, as in the example described above, the first shape may be configured to shift in the display area 50. In this case, displayed may be such an action that the first shape shifting in the display area 50 is transformed into the second shape at a certain time (random time, for example) on the spot, and that the second shape after transformation shifts in the display area 50 from that spot. According to this display, action patterns corresponding to the respective shapes may be defined such that action patterns of the first shape and the second shape during shift in the display area 50 differ from each other. Subsequently, parameters for controlling the shifting actions of the first shape, and parameters for controlling the shifting action of the second shape may be determined based on feature values of user image data. In this case, movements of the user objects become more diverse.

### Modified Example of First Embodiment

A detection sensor for detecting a position of an object may be provided near the screen 12 of the display system 1 according to the first embodiment. For example, the detection sensor includes a light emitter and a light receiver of infrared light. The detection sensor detects presence of an object in a predetermined range and a position of the object by emitting infrared light via the emitter, and receiving reflection light of the emitted infrared light via the receiver. Alternatively, the detection sensor may include a camera, and detect a distance to a target object, and a position of the target object based on an image of the target object included in an image captured by the camera. When the detection sensor is provided on the projection-receiving surface side of the screen 12, the detection sensor is capable of detecting a user approaching the screen 12. A detection result acquired from the detection sensor is sent to the display control device 10.

The display control device 10 associates the position of the object detected by the detection sensor with coordinates of the position in the image 13 displayed on the screen 12. As a result, correlation is made between the position coordinates of the detected object and coordinates of the detected object in the display area 50. When any one of the second user objects 58 is present within a predetermined range from coordinates defined in the display area 50 and correlated with the position coordinates of the detected object, the display control device 10 may cause a predetermined action of the corresponding second user object 58.

For example, when the user points at the particular second user object 58 displayed in the image 13 of the display system 1 having this structure while extending the arm or the like in front of the screen 12, the particular second user object 58 may exhibit an effect such as performance of a special action in accordance with the movement of the user. The special action may be a jumping action of the particular second user object 58, or display of the title image data 530 given near the particular second user object 58, for example.

According to this configuration, it is preferable that the display control device 10 recognizes detection only within a predetermined period (e.g., 0.5 seconds) from the moment of detection of the object by the detection sensor, for example. In this case, a state of continuous detection of an identical object is avoidable.

According to the display system 1 in the modified example of the first embodiment, the detection sensor for detecting a position of an object is provided to cause a predetermined action of the second user object 58 in the display area 50 in accordance with a detection result of the detection sensor. Accordingly, the display system 1 in the modified example of the first embodiment is capable of providing an interactive environment for the user.

### Second Embodiment

A second embodiment is hereinafter described. According to the first embodiment described above, a drawing based on a first shape is created on a sheet. According to the second embodiment, however, a drawing based on a second shape is created on a sheet.

According to the second embodiment, the configurations of the display system 1 and the display control device 10 of the first embodiment described above are adoptable without change.

FIGS. 23-1 and 23-2 illustrate an example of a document sheet adoptable in the second embodiment. Each of the sheets illustrated in the figures is a sheet on which the user creates a second shape. It is assumed herein that the shapes 41a, 41b, 41c, and 41d described with reference to FIGS. 9A through 9D are adopted as the second shapes. The document sheets illustrated in FIGS. 23-1 and 23-2 correspond to the shapes 41a and 41b, respectively, of the shapes 41a, 41b, 41c, and 41d.

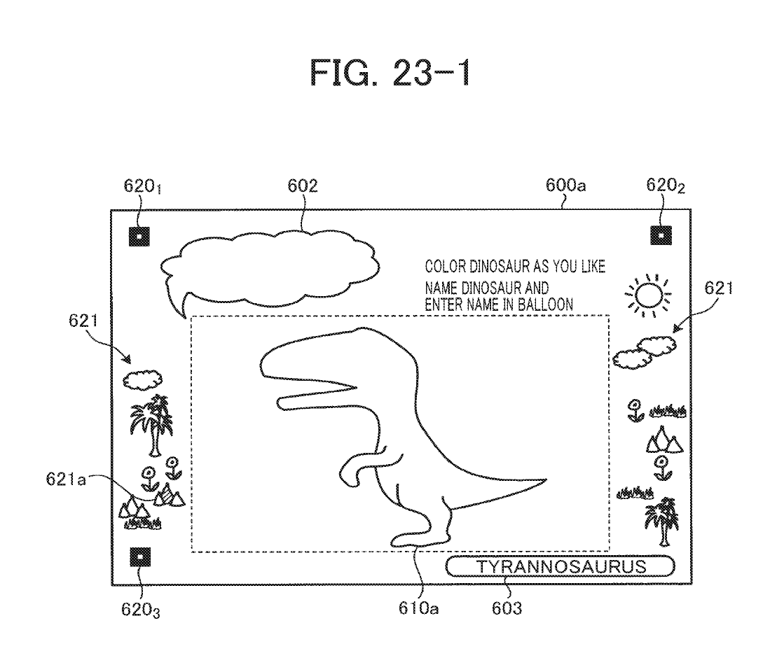

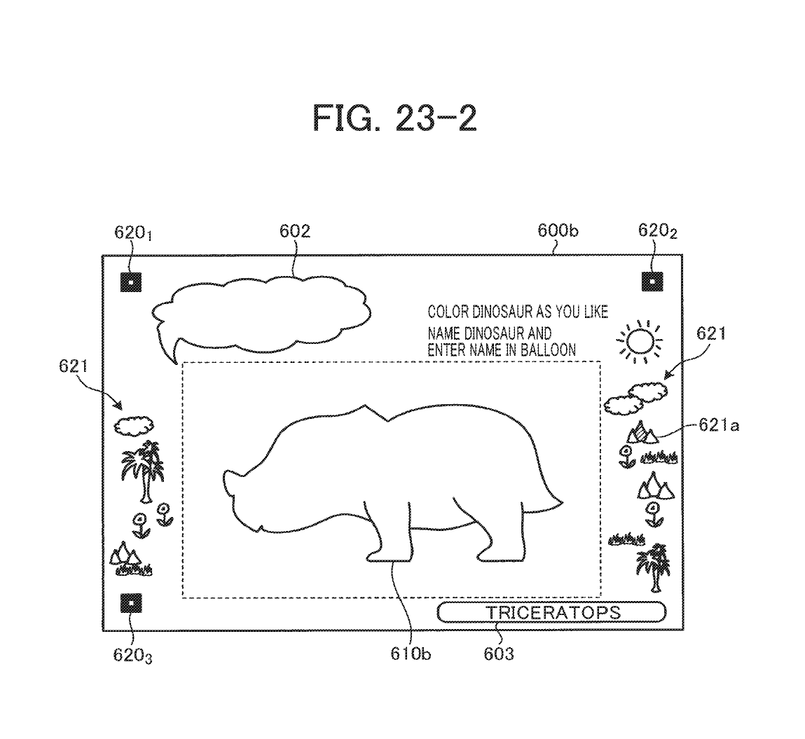

FIG. 23-1 illustrates an example of a sheet 600a corresponding to the shape 41a. The sheet 600a illustrated in FIG. 23-1 includes a drawing area 610a formed along the side of the shape 41a on which a pattern for a dinosaur represented by the shape 41a is created, and a title entry area 602 for entry of a title corresponding to the drawing in the drawing area 610a. A name of a dinosaur corresponding to the target of the sheet 600a is printed in an area 603 beforehand.

Markers 620₁, 620₂, and 620₃ for detecting the orientation and size of the sheet 600a are disposed at three of four corners of the sheet 600a. According to the example illustrated in FIG. 23-1, an area 621 including objects of illustrations is disposed on each side of the sheet 600a in the vertical direction. The objects provided in the areas 621 include an object 621a disposed in a central lower portion of the area 621 on the left side. The object 621a is a marker indicating that the sheet 600a is a sheet for the shape 41a. The object 621a used as a marker is hereinafter referred to as the marker object 621a.

FIG. 23-2 illustrates an example of a document sheet 600b corresponding to the shape 41b. Similarly to the sheet 600a, the sheet 600b illustrated in FIG. 23-2 includes a drawing area 610b formed along the shape 41b, and the title entry area 602. However, the marker object 621a in the sheet 600b is disposed at a position different from the position of the marker object 621a of the sheet 600a described above. According to this example, the marker object 621a is disposed at a central upper portion of the area 621 on the right side of the sheet 600b.

The document sheets 600a and 600b are hereinafter collectively referred to as sheets 600, the drawing areas 610a and 610b are collectively referred to as drawing areas 610, and the markers 620₁ through 620₃ are collectively referred to as markers 620, unless specified otherwise.

As described above, each of the document sheets 600 includes the drawing area 610 formed along the design of the second shape which is actually displayed in the display area 50 and performs a shift or other actions, the title entry area 602, the markers 620 used for detecting the position, orientation, and size of the document sheet, and the marker object 621a used for specifying the design of the second shape included in the sheet 600. This configuration is applicable to the shapes 41c and 41d. The marker objects 621a included in the sheets 600 prepared for the shapes 41a, 41b, 41c, and 41d are disposed at positions different from each other.

The positions of the marker objects 621a corresponding to the respective shapes 41a, 41b, 41c, and 41d are determined beforehand. Accordingly, the extractor 110 acquires image data indicating the position (area) of the marker object 621a specifying the corresponding shape from document image data read and acquired from the sheet 600, and determines the selected shape 41a, 41b, 41c, or 41d included in the sheet 600 based on the position from which the marker object 621a has been acquired.

The method for determining the type of shape included in the sheet 600 is not limited to the foregoing method which changes the position of the marker object 621a for each shape. For example, the type of shape of the sheet 600 may be determined by a method which provides the marker object 621 a located on the same position of the sheet 600 but having a different design for each shape. In this case, image data indicating the position of the marker object 621a is acquired. Thereafter, the type of shape included in the sheet 600 is determined based on the design of the acquired marker object 621a. Alternatively, the method using different positions and the method using different designs may be combined such that the marker object 621a represented by a combination of uniquely determined position and design is provided for each shape with one-to-one correspondence.

### Document Image Reading Process in Second Embodiment

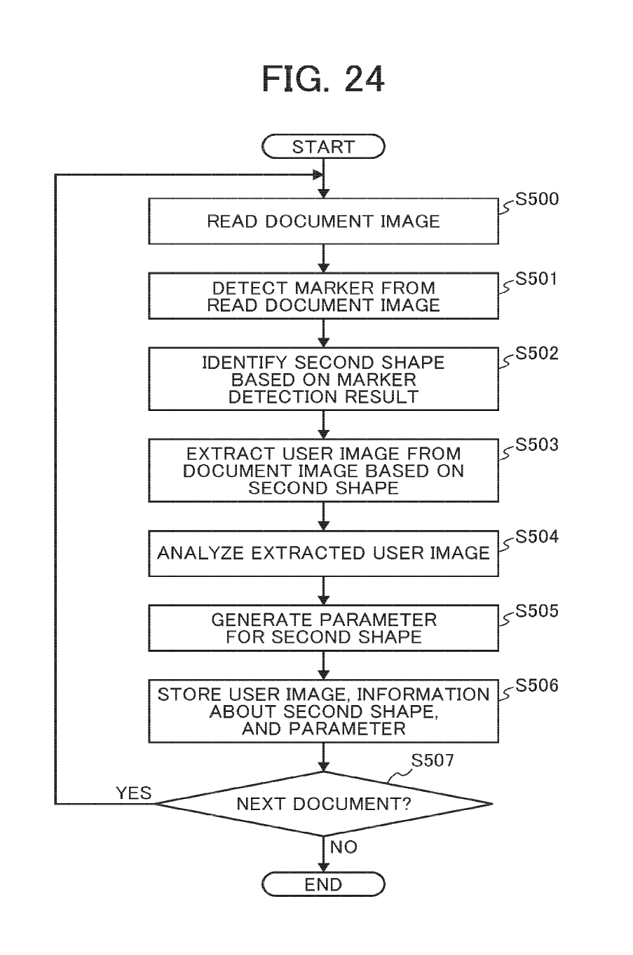

FIG. 24 is a flowchart illustrating an example of a document image reading process according to the second embodiment. A handwritten drawing is initially created by the user prior to execution of the process illustrated in this flowchart.

It is assumed in the following description that the image controller 101 switches display of the first user object based on the first shape representing an egg shape to display of the second user object based on the second shape representing a dinosaur shape to express hatching of a dinosaur from an egg in the image 13. According to the second embodiment, the first user object represents a well-known white egg, for example. More specifically, the first user object has the first shape designed in an ordinary color. Even when a plurality of document sheets on which a plurality of users create different drawings are read, each of the first user objects has a design in the same color prepared beforehand. The user creates a handwritten drawing displayed on the second user object corresponding to the second shape on any one of the document sheets 600a through 600d. According to the second shape representing a dinosaur in this example, the handwritten drawing is displayed on the second user object as a pattern on the dinosaur.

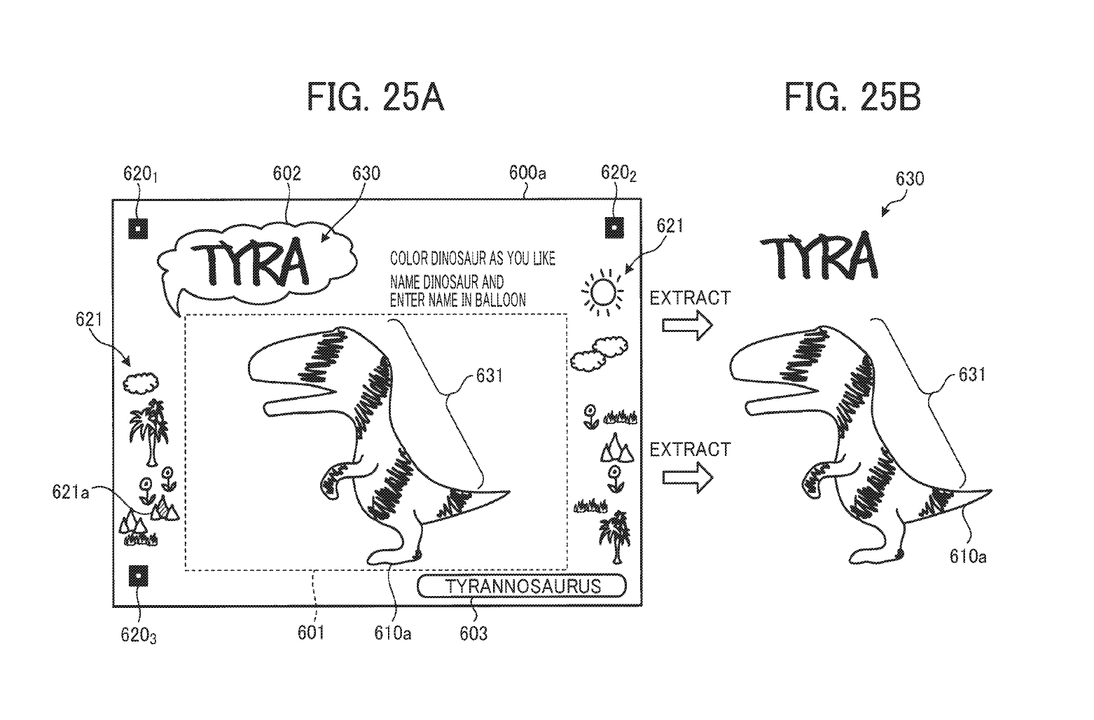

It is assumed in the description herein that the user selects the sheet 600a, and creates a drawing 631 in the drawing area 610a of the sheet 600a as illustrated in 25A. It is assumed that the drawing 631 is a pattern formed on the side of the second user object. According to the example illustrated in FIG. 25A, a title image 630 indicating a title is formed in the title entry area 602.

In the flowchart illustrated in FIG. 24, an image of the sheet 600a including the handwritten drawing 631 created by the user is read by the scanner device 20. Document image data indicating the read image is sent to the display control device 10, and input to the inputter 100 in step S500.

In subsequent step S501, the extractor 110 of the inputter 100 extracts the corresponding marker object 621a from the input document image data. In subsequent step S502, the extractor 110 identifies one of the shapes 41a through 41d as the second shape corresponding to the document sheet from which the document image has been read based on the marker object 621a extracted in step S501.

It is assumed in the following description that the sheet 600a corresponding to the shape 41a has been selected.

In subsequent step S503, the image acquirer 111 of the inputter 100 extracts user image data from the document image data input in step S500 based on the drawing area 610a of the sheet 600a. The image acquirer 111 acquires an image in the title entry area 602 of the sheet 600a as title image data. Illustrated in FIG. 25B is an example of the image corresponding to the image data indicating the drawing area 610a and the title entry area 602 extracted from the document image data.

After user image data indicating the drawing area 610a and the title image data 630 written to the title entry area 602 are acquired by the image acquirer 111, the inputter 100 transfers the user image data and the title image data 630 to the image controller 101.

In subsequent step S504, the parameter generator 120 of the image controller 101 analyzes the user image data extracted in step S503. In subsequent step S505, the parameter generator 120 of the image controller 101 generates respective parameters for the second user object corresponding to the user image data based on an analysis result of the user image data.

The parameter generator 120 analyzes the user image data in a manner similar to the manner of the first embodiment, and calculates respective feature values of the user image data, such as color distribution and edge distribution, and the area and the center of gravity of the drawing part included in the user image data. The parameter generator 120 generates the respective parameters for the second user object based on the one or more feature values included in the respective feature values calculated from the analysis result of the user image data.

In subsequent step S506, the storing unit 122 of the image controller 101 stores, in the memory 1004, information indicating the second shape identified in step S502, the user image data, and the respective parameters generated by the parameter generator 120. The storing unit 122 of the image controller 101 further stores the title image in the memory 1004.

In subsequent step S507, the inputter 100 determines presence or absence of a next document image to be read. When the inputter 100 determines that a next document image to be read is present (“Yes” in step S507), the processing returns to step S500. On the other hand, when the inputter 100 determines that a next document image to be read is absent (“No” in step S507), a series of processes in the flowchart of FIG. 24 ends.

### Display Control Process in Second Embodiment

A display control process according to the second embodiment is substantially identical to the display control process described with reference to the flowchart of FIG. 10 according to the first embodiment. In the second embodiment herein, the first user object based on the first shape has no pattern. Accordingly, step S202 in FIG. 10 is omitted.

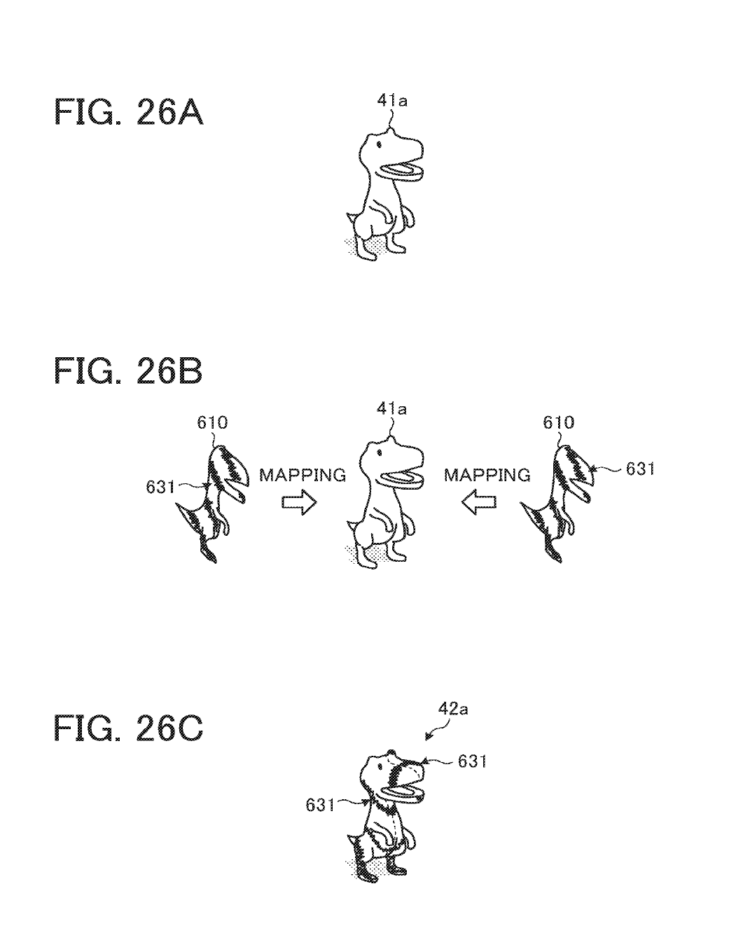

Mapping of user image data indicating the second shape according to the second embodiment, as mapping corresponding to the process in step S203 of FIG. 10, is hereinafter described with reference to FIGS. 26A through 26C. FIGS. 26A through 26C each illustrate an example of generation of the second user object applicable to the second embodiment. FIG. 26A illustrates the shape 41a corresponding to the second shape.

FIG. 26B illustrates an example of mapping of user image data on the shape 41a. According to the second embodiment, user image data indicating the drawing 631 created along a contour is mapped on each of one half surface and the other half surface of the shape 41a in the drawing area 610a of the sheet 600a corresponding to the shape 41a as indicated by arrows in FIG. 26B. In other words, according to this example, two copies of the user image data indicating the drawing 631 are mapped. FIG. 26C illustrates an example of a second user object 42a generated in this manner. The mapper 121 stores the generated second user object 42a in the memory 1004, for example, similarly to the above example.

According to the second embodiment, the processing performed when the first user object and the second user object appear in the display area 50 is similar to the corresponding processing described in step S204 and steps after S204 in the flowchart of FIG. 10. Accordingly, the same description is not repeated herein. Moreover, according to the second embodiment, a display control process for the second user object is similar to the corresponding processing described with reference to the flowchart of FIG. 14. Furthermore, a process performed in response to an event is also similar to the processing described with reference to the flowchart of FIG. 16. Accordingly, the same description of these processes is not repeated herein.

As described above, according to the display system 1 of the second embodiment, the user selects the second shape desired to display from the plurality of document sheets 600 including different designs of the second shape, and creates a drawing on the selected sheet 600 to display the second shape reflecting the drawing contents (patterns) in the display area 50. In addition, unlike a marker for aligning a position or an orientation, the marker object 621a is extractable from image data indicating the orientation and position of the sheet 600 already determined. Accordingly, the marker object 621a may be any type of object as long as the object has a certain design of a shape. According to the example disclosed in the second embodiment, therefore, the marker object 621a is a design object matched with the object and the background displayed by the display system 1 in the display area 50 as illustrated in FIGS. 23-1 and 23-2.

According to the second embodiment, the first user object to be displayed does not include the drawing contents of the user image data created in the drawing area 610. However, other configurations may be adopted. For example, the method adopted in the first embodiment may be performed in a reverse manner to display the first user object having the first shape reflecting the user image data created in the drawing area 610 based on the second shape.

### Third Embodiment

A third embodiment is hereinafter described. The third embodiment is an example which uses, as a document sheet on which a drawing is created by the user, both the sheet 500 on which the first shape is created as in the first embodiment, and the document sheets 600a through 600d on each of which the second shape is created as in the second embodiment.

According to the third embodiment, the configurations of the display system 1 and the display control device 10 according to the first embodiment described above are adoptable without change. It is assumed that the respective markers 520₁ through 520₃ included in the sheet 500 have the same shapes as the shapes of the respective markers 620₁ through 620₃ included in the sheets 600. It is further assumed that the extractor 110 is capable of extracting the respective markers 520₁ through 520₃ and the respective markers 620₁ through 620₃ without distinction, and determining the orientation and size of the corresponding document sheet.

Moreover, according to the third embodiment, it is assumed that the marker object 621a for distinction between the sheet 500 including a design of the first shape, and the sheet 600 including a design of the second shape is disposed on each of the document sheets. It is further assumed that selection of the design of the second shape included in the sheet 600 from the respective second shapes is recognizable based on the marker object 621a.

### Document Image Reading Process in Third Embodiment

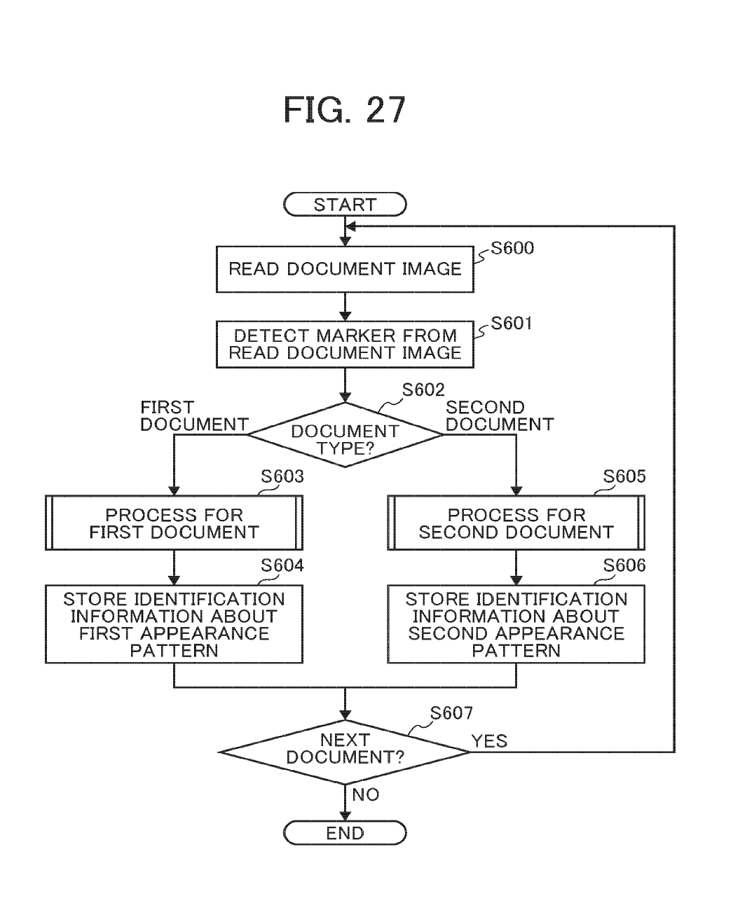

FIG. 27 is a flowchart illustrating an example of a document image reading process according to the third embodiment. In the process of the flowchart illustrated in FIG. 27, an image is read by the scanner device 20 from any one of the document sheets 500, and 600a through 600d. Document image data indicating the read image is sent to the display control device 10, and input to the inputter 100 in step S600.

In subsequent step S601, the extractor 110 of the inputter 100 performs an extraction process for extracting the respective markers 520₁ through 520₃ or the respective markers 620₁ through 620₃ from the input document image data, and extracting the marker object 621a based on the positions of the extracted markers.

In subsequent step S602, the extractor 110 determines, based on a result of the process in step S601, the document type of the document sheet from which the document image data is read. For example, the extractor 110 determines, based on the marker object 621a extracted from the corresponding document sheet, the shape of the design included in the type of the document sheet. The marker object 621a may be removed from the sheet 500 to distinguish between the sheet 500 including the design of the first shape and the document sheets 600 each including the design of the selected second shape. In this case, the extractor 110 may determine that the document sheet from which the document image data has been read is the sheet 500 (first document sheet) including the design of the first shape when the marker object 621a is not extractable from the document image data. On the other hand, the extractor 110 may determine that the document sheet is one of the document sheets 600 (second document sheet) including the design of the second shape when the marker object 621a is extractable.

When the extractor 110 determines that the document sheet is the first document sheet (“First document sheet” in step S602), the processing proceeds to step S603.

In step S603, the inputter 100 and the image controller 101 execute processing for the sheet 500 based on the processes in steps S101 through S105 in the flowchart of FIG. 6. In subsequent step S604, the storing unit 122, for example, of the image controller 101 stores, in the memory 1004, identification information (e.g., flag) indicating a first appearance pattern for appearance of the first user object 56 in the display area 50. The first appearance pattern herein is an appearance pattern for appearance of the first user object 56 in the display area 50 after user image data indicating the drawing 531 created by the user is mapped on the first user object 56 as described in the first embodiment by way of example.

After the identification information indicating the first appearance pattern is stored, the processing proceeds to step S607.

On the other hand, when the extractor 110 determines in step S602 that the document sheet is the second document sheet (“Second document sheet” in step S602), the processing proceeds to step S605.

In step S605, the inputter 100 and the image controller 101 perform processing for the document sheet 600 based on the processes in steps S502 through S506 in the flowchart of FIG. 24. In subsequent step S606, the storing unit 122, for example, of the image controller 101 stores, in the memory 1004, identification information indicating a second appearance pattern for appearance of the first user object 56 in the display area 50. The second appearance pattern herein is an appearance pattern of the first user object 56 having a fixed color in the display area 50 as described in the second embodiment by way of example.

After identification information indicating the first appearance pattern or the second appearance pattern is stored in step S604 or step S606, the processing proceeds to step S607.

In step S607, the inputter 100 determines presence or absence of a next document image to be read. When the inputter 100 determines that a next document image to be read is present (“Yes” in step S607), the processing returns to step S600. On the other hand, when the inputter 100 determines that a next document image to be read is absent (“No” in step S607), a series of processes in the flowchart of FIG. 27 ends.

### Display Control Process in Third Embodiment

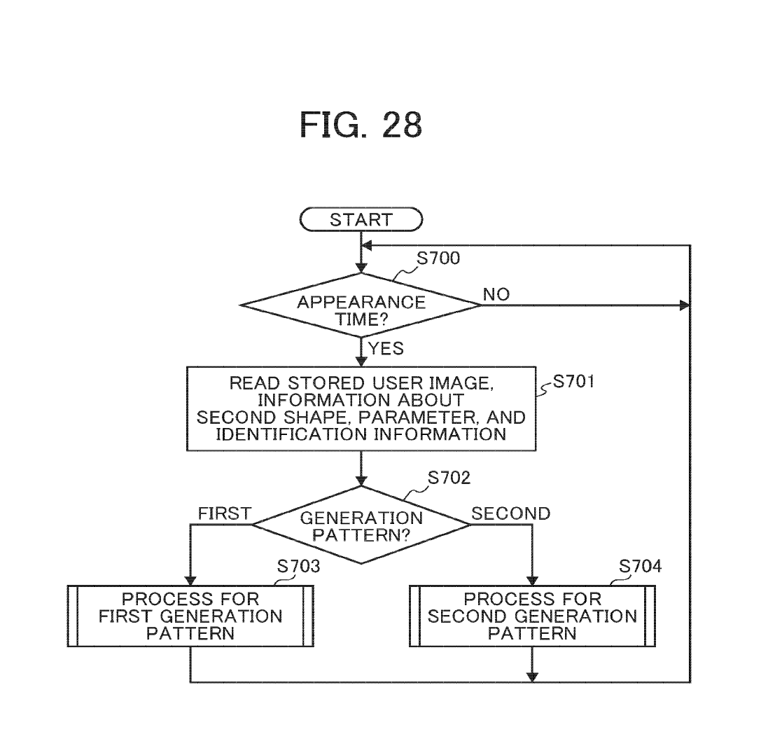

FIG. 28 is a flowchart illustrating an example of a display control process performed in accordance with a drawing created by the user on the sheet 500 or the document sheets 600a through 600d according to the third embodiment.

In step S700, the image controller 101 determines whether or not the current time is a time for allowing a user object corresponding to the drawing on the sheet 500 or the document sheets 600a through 600d to appear in the display area 50. When the image controller 101 determines that the current time is not a time for appearance (“No” in step S700), the processing returns to step S700 to wait for a time for appearance. On the other hand, when the image controller 101 determines that the current time is a time for appearance of the user object (“Yes” in step S700), the processing proceeds to step S701.

In step S701, the storing unit 122 of the image controller 101 reads, from the memory 1004, user image data, information and parameters indicating the second shape, and identification information indicating an appearance pattern of the first user object 56 in the display area 50. In subsequent step S702, the image controller 101 determines selection of the first appearance pattern or the second appearance pattern as the appearance pattern of the first user object 56 based on the identification information read by the storing unit 122 from the memory 1004 in step S701.

When the image controller 101 determines that the appearance pattern of the first user object 56 is the first appearance pattern (“First” in step S702), the processing proceeds to step S703 to perform the display control process corresponding to the first appearance pattern. More specifically, the image controller 101 executes the processes in step S202 and steps after step S202 in the flowchart of FIG. 10.

On the other hand, when the image controller 101 determines that the appearance pattern of the first user object 56 is the second appearance pattern (“Second” in step S702), the processing proceeds to step S704 to perform the display control process corresponding to the second appearance pattern. More specifically, the image controller 101 executes the processes in step S203 and steps after step S203 in the flowchart of FIG. 10.

After completion of the process in step S703 or step S704, a series of processes in the flowchart of FIG. 28 ends.

According to the third embodiment, a display control process for the second user object 58 is similar to the processing described with reference to the flowchart of FIG. 14, while a process in response to occurrence of an event is similar to the processing described with reference to the flowchart of FIG. 16. Accordingly, description of these processes is not repeated herein.

As described above, the display system 1 according to the third embodiment is applicable to such a case which uses both the sheet 500 including a drawing mapped on the first shape, and the document sheets 600a through 600d each including a drawing mapped on the second shape.

According to the embodiments of the present invention, therefore, a handwritten user image created by a user performs actions with various changes. Accordingly, more interest and concern are expected to be attracted from the user.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. A display control apparatus, comprising:
one or more processors; and
a memory to store a plurality of instructions which, when executed by one or more processors, cause the processors to:
acquire a user image having a first shape, the user image including a drawing image that has been manually drawn by a user;
control one or more displays to display a first image having the first shape, created based on the user image, in a display area of a display medium, and further display a second image having a second shape different from the first shape, created based on the user image, in the display area of the display medium.

2. The display control apparatus of claim 1, further comprising:
a receiver to receive the user image including the drawing image, from an image input device, the drawing image being acquired at the image input device by reading an image manually drawn by the user in a predetermined area of a recording sheet, the predetermined area having the first shape, and
wherein the processors further create the first image reflecting and the second image, each reflecting the user image.

3. The display control apparatus of claim 1, further comprising:
a receiver to receive the user image including the drawing image, from an image input device, the drawing image being acquired at the image input device by reading an image manually drawn by the user in a predetermined area of a recording sheet, the predetermined area having the second shape, and
wherein the processors further create the first image not reflecting the user image, and the second image reflecting the user image.

4. The display control apparatus of claim 1,
wherein the processors further control the displays to display a third image in the display area of the display medium at a predetermined time, and shift the second image in a direction away from the third image when the third image appears in the display area.

5. The display control apparatus of claim 4,
wherein the processors control the displays to display the second image, such that the second image is shifted to an area other than the display area of the display medium when the third image appears in the display area.

6. A display system, comprising:
an image input device to input a drawing image that has been manually drawn by a user to generate a user image, the user image having a first shape;
an image processing device to perform image processing on the user image input from the image reading device; and
one or more display devices to display the user image on a display medium,
the image processing device including circuitry to:
acquire the user image from the image reading device;
control the one or more display devices to display a first image having the first shape, created based on the user image, in a display area of the display medium, and further display a second image having a second shape different from the first shape, created based on the user image, in the display area of the display medium.

7. The display system of claim 6,
wherein the image input device acquires the drawing image by reading an image manually drawn by the user in a predetermined area of a recording sheet, the predetermined area having the first shape, and
the image processing device further creates the first image reflecting and the second image, each reflecting the user image.

8. The display system of claim 6,
wherein the image input device acquires the drawing image by reading an image manually drawn by the user in a predetermined area of a recording sheet, the predetermined area having the second shape, and
wherein the image processing device further creates the first image not reflecting the user image, and the second image reflecting the user image.

9. The display system of claim 6,
wherein the image processing device further controls the displays to display a third image in the display area of the display medium at a predetermined time, and shift the second image in a direction away from the third image when the third image appears in the display area.

10. The display system of claim 9,
wherein the image processing device controls the displays to display the second image, such that the second image is shifted to an area other than the display area of the display medium when the third image appears in the display area.

11. The system of claim 6,
wherein the image input device includes a scanner that scans the drawing image drawn to a recording sheet, to generate the user image.

12. The system of claim 6,
wherein the one or more display devices include a plurality of projectors disposed side by side.

13. A display control method comprising:
acquiring a user image having a first shape, the user image including a drawing image that has been manually drawn by a user;
displaying a first image having the first shape, created based on the user image, in a display area of a display medium; and
displaying a second image having a second shape different from the first shape, created based on the user image, in the display area of the display medium.

14. The display control method according to claim 13, wherein the drawing image is acquired by reading an image manually drawn by the user in a predetermined area of a recording sheet, the predetermined area having the first shape, the method further comprising:
creating the first image reflecting and the second image, each reflecting the user image.

15. The display control method according to claim 13, wherein:
the drawing image is acquired by reading an image manually drawn by the user in a predetermined area of a recording sheet, the predetermined area having the second shape, the method further comprising:
creating the first image not reflecting the user image; and
creating the second image reflecting the user image.

16. The display control method according to claim 13, further comprising:
displaying a third image in the display area of the display medium at a predetermined time; and
shifting the second image in a direction away from the third image when the third image appears in the display area.

17. The display control method according to claim 16, wherein the shifting the second image includes
shifting the second image to an area other than the display area of the display medium when the third image appears in the display area.
